(19) United States
(12) Patent Application Publication
(10) Pub. No.: US 2026/0172665 A1
(43) Pub. Date: Jun. 18, 2026

(54) IMAGE PROCESSING APPARATUS AND IMAGE PROCESSING METHOD FOR AUTOMATIC IMAGE CAPTURING

(71) Applicant: CANON KABUSHIKI KAISHA, Tokyo (JP)

(72) Inventor: KENICHI ARAI, Saitama (JP)

(21) Appl. No.: 19/417,123

(22) Filed: Dec. 11, 2025

(30) Foreign Application Priority Data
Dec. 16, 2024 (JP) 2024-220208
Oct. 7, 2025 (JP) 2025-169776

(51) Int. Cl. H04N 23/611; G06V 40/16; G06V 40/50; H04N 23/667

(52) U.S. Cl. CPC H04N 23/611; G06V 40/168; G06V 40/50; H04N 23/667

(57) ABSTRACT

Provided is an image processing apparatus including an image pickup unit configured to pick up an image of a subject, a search unit configured to search for the subject detected from image data obtained by the image pickup unit, an authentication registration unit configured to authenticate and store information about the subject detected as a result of the search, and a control unit configured to control image pickup by the image pickup unit based on the information stored by the authentication registration unit, in which in order to determine whether authentication registration by the authentication registration unit is to be performed, the control unit performs switching of a first authentication registration determination mode for determining whether or not a first discrimination condition is met and a second authentication registration determination mode for determining whether or not a second condition different from the first discrimination condition is met.

### BACKGROUND

### Field of the Technology

The present disclosure relates to techniques for automatic image capturing and individual authentication registration in an image processing apparatus and an image processing method.

### Description of the Related Art

In recent years, an automatic image capturing camera configured to periodically and continuously perform image capturing without image capturing instructions issued from a user has been developed and put into practical use.

For example, a camera has been proposed which has a pan, tilt, and zoom (PTZ) mechanism and controls, when a subject within an image capturing range of the camera is detected, the PTZ mechanism to track the subject such that the subject is within an image pickup angle of view and to release a shutter.

In the above-described automatic image capturing camera, a user desires to perform image capturing that focuses on or features key people such as family and friends, and on the other hand, the user does not desire to capture many images of unrelated people such as store clerks or strangers passing by.

In view of the above, for example, by registering feature information of the key people in the camera and designating registered people to be tracked and captured by priority, the user can capture images that focus on those people.

Japanese Patent Laid-Open No. 2022-70684 describes a technique with which an image pickup apparatus is included with an individual authentication function of storing information of a subject and using the information to determine an image capturing target and automatically performs image capturing by tracking the subject and adjusting a composition based on the stored information while a pan, tilt, or zoom operation is performed.

Individual authentication is a process of identifying an individual by quantifying a feature amount such as a face, but this image pickup apparatus is further included with a function of automatically registering a person without individual authentication information while automatic image capturing is performed.

Expected use cases where the automatic image capturing camera is used include a case of installing the camera in a party venue for a home party, a barbeque, or the like and carrying the camera with a user when the user moves to an activity space or the like outside the party venue to play, for example.

### SUMMARY

An image processing apparatus according to an aspect of the present disclosure is an image processing apparatus capable of controlling automatic image capturing and automatic authentication registration, the image processing apparatus including at least one processor and at least one memory storing a program which, when executed by the at least one processor, causes the at least one processor to function as a search unit configured to search for a subject detected from image data obtained by picking up an image of the subject by an image pickup unit, an authentication registration unit configured to perform authentication registration by authenticating the subject detected as a result of the search by the search unit and storing information about the subject, and a control unit configured to control image pickup by the image pickup unit based on the information stored by the authentication registration unit, in which in order to determine whether the authentication registration by the authentication registration unit is to be performed, the control unit has a first authentication registration determination mode for determining whether or not a first discrimination condition is met, and a second authentication registration determination mode for determining whether or not a second discrimination condition different from the first discrimination condition is met, and the control unit performs switching of authentication registration determination modes including the first authentication registration determination mode and the second authentication registration determination mode by using at least one or more pieces of information among mode switching input information provided by a user, position information, time information, or sensor information.

Features of the present disclosure will become apparent from the following description of embodiments with reference to the attached drawings. The following description of embodiments is described by way of example.

### BRIEF DESCRIPTION OF THE DRAWINGS

FIG. 1A schematically illustrates an external appearance of a camera according

to an embodiment.

FIG. 1B schematically illustrates a drive direction of the camera according to the embodiment.

FIG. 2 is a block diagram illustrating a hardware configuration of the camera according to the embodiment.

FIG. 3 illustrates a configuration example of a wireless communication system between the camera and an external apparatus.

FIG. 4 is a block diagram illustrating a configuration of the external apparatus of FIG. 3.

FIG. 5 is a block diagram illustrating a configuration of an image pickup apparatus.

FIG. 6 is a table illustrating an example of personal information.

FIG. 7 illustrates an example of a screen of the personal information displayed on the external apparatus.

FIG. 8A illustrates an example of image data.

FIG. 8B is a table illustrating an example of subject information.

FIG. 9 is a table illustrating a condition for adding a registration count and the registration count for each registration determination mode.

FIG. 10 is a flowchart for describing an outline of a periodic operation by the image pickup apparatus.

FIG. 11A is a flowchart for describing provisional registration determination processing.

FIG. 11B is a table illustrating the provisional registration count.

FIG. 11C is a table for describing the provisional registration determination processing.

FIG. 12A illustrates an example of image data after an adjustment of an angle of view by a provisional registration determination.

FIG. 12B is a table illustrating an example of subject information of the image data of FIG. 12A after the adjustment of the angle of view by the provisional registration determination.

FIG. 13A is a flowchart for describing full registration determination processing.

FIG. 13B is a table for describing the full registration determination processing.

FIG. 13C is a table for describing the full registration determination processing.

FIG. 14 is a flowchart for describing first full registration count determination processing.

FIG. 15 is a flowchart for describing second full registration count determination processing.

FIG. 16A is a flowchart for describing image capturing target determination processing.

FIG. 16B is a table for describing the image capturing target determination processing.

FIG. 17A illustrates an example of image data.

FIG. 17B is a table illustrating an example of subject information.

FIG. 18 illustrates an image example after an adjustment of the angle of view by an image capturing target determination.

FIG. 19 is a flowchart for describing registration determination mode switching by a user input.

FIG. 20 illustrates a screen example of a position range designation using position information by the external apparatus.

FIG. 21 is a flowchart for describing the registration determination mode switching by GPS position range information.

FIG. 22 is a flowchart for describing the registration determination mode switching by position range information obtained by a sensor.

### DESCRIPTION OF THE EMBODIMENTS

Hereinafter, embodiments of the present disclosure will be described in detail

with reference to the accompanying drawings.

According to a related art technique, automatic authentication registration of people who can be determined to be key people is performed in a case where conditions such as a face size, a face position, a face direction, and a face confidence score of a person are met; however:
participants and the like are not registered because they do not usually meet each other, and a period during which image capturing is desired to be performed is only during the party, so that it is desired to promptly register those people; and
in a case where a user leaves a private area secluded from strangers and takes a camera out to use the camera in a public area where an unspecified number of people who are not acquaintances are present, like an activity space, the user does not desire to perform the automatic authentication registration of the people who are not acquaintances.

In addition, it is difficult to respond to different requirements according to a scene. For example, in a case where the number of registered people exceeds an upper limit, it is conceivable that information of an acquaintance is deleted and a person who is not an acquaintance is registered in an overwriting manner.

Moreover, in a case of a public area, when it is desired that deletion of registration of acquaintances is avoided, it is possible to designate protection of the registered person using a smartphone application or the like and avoid the deletion. However, in a use case such as a party, it is cumbersome for the user to go through the trouble of a registration protection operation.

The present disclosure is aimed to provide appropriate personal registration according to a use case in an image pickup apparatus capable of automatic individual authentication registration without inconveniencing the user.

First, a technical background with regard to the present disclosure will be described. A panning operation and a tilting operation of the image pickup apparatus is automatically performed to search for a subject in a surrounding environment, and an image is captured within an angle of view including the detected subject, in order to increase the possibility of being able to record image information that is satisfactory to the user.

In the image pickup apparatus capable of automatically controlling an image capturing direction, it is demanded not to miss an image capturing timing while searching for a subject set as an image capturing target at the same time. By taking into account the number of subjects, movement directions, and backgrounds, while an image capturing composition is adjusted based on panning and tilting mechanisms and a zoom mechanism, an image capturing operation is to be promptly performed once catching a correct image capturing timing.

Furthermore, by using individual authentication information, a subject to be captured by priority in the search can be sensed, and in the image capturing, the individual authentication information can be used for a determination on a subject to be captured within the angle of view. For this reason, it is possible to increase a possibility to be able to record an image that is satisfactory to the user.

In a case where in the image pickup apparatus capable of performing automatic image capturing, registration of individual authentication is not automatically executed, convenience may be significantly reduced. Identification processing of an individual in the individual authentication is performed by quantifying a feature amount obtained from a face image. However, when a numerical value changes due to a change accompanying a person's growth, a subtle angle change of the face, or a slight variation in the light with which the face is irradiated, and the like, there is a possibility that the person is no longer deemed to be the same person even in a case where the person is originally to be considered as the same person. In this case, when the subject is erroneously recognized as a different person by an erroneous authentication in subject tracking control, an issue occurs that as a result of tracking the different person by the image pickup apparatus, an image capturing opportunity of a person originally desired to be captured is missed. Therefore, in the image pickup apparatus capable of performing automatic image capturing, a reliability of the individual authentication is directly linked to a reliability of automatic image capturing. With regard to the registration information of the individual authentication for the same person, it is important to attempt to maintain and improve the authentication accuracy by using a plurality of pieces of registration information by adding the registration information as needed, and the update of the registration information is to be automatically performed. To realize higher performance automatic image capturing with high convenience, automatic registration of individual authentication becomes very important.

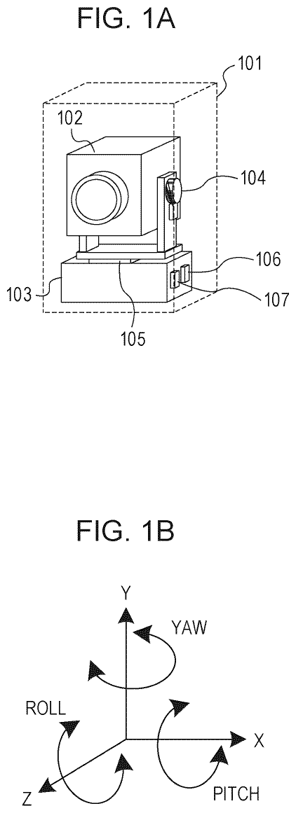

FIG. 1A schematically illustrates an external appearance of the image pickup apparatus according to an embodiment. A camera 101 is provided with an operation member for camera operation in addition to a power source switch. A lens barrel 102 integrally includes an image pickup element and an imaging lens group serving as an image pickup optical system configured to pick up an image of a subject and is movably attached to a control box (stationary part) 103 of the camera 101. Specifically, the lens barrel 102 is attached to the control box (stationary part) 103 via a tilt rotation unit 104 and a pan rotation unit 105 serving as mechanisms that can be rotated and driven relative to the control box (stationary part) 103 and enables a change in an image capturing direction. The tilt rotation unit 104 is a unit configured to drive the lens barrel 102 in a tilting direction (hereinafter, which will be referred to as a tilt rotation unit). The pan rotation unit 105 is a unit configured to drive the lens barrel 102 in a panning direction (hereinafter, which will be referred to as a pan rotation unit). An angular velocity meter 106 and an accelerometer 107 are arranged in the control box (stationary part) 103 of the camera 101. For example, the angular velocity meter 106 includes a gyro sensor, and the accelerometer 107 includes an acceleration sensor.

FIG. 1B is a schematic diagram illustrating a relationship among a three-dimensional Cartesian coordinate system (an X axis, a Y axis, and a Z axis) and three directions (pitch, yaw, and roll). The X axis (horizontal axis), the Y axis (vertical axis), and the Z axis (axis in a depth direction) are respectively defined with reference to positions of the control box (stationary part) 103. An X axis rotational direction is set as a pitch direction, a Y axis rotational direction is set as a yaw direction, and a Z axis rotational direction is set as a roll direction.

The tilt rotation unit 104 includes a motor drive mechanism capable of rotating and driving the lens barrel 102 in the pitch direction illustrated in FIG. 1B. The pan rotation unit 105 includes a motor drive mechanism with which the lens barrel 102 can be rotated and driven in the yaw direction illustrated in FIG. 1B. That is, the camera 101 includes mechanisms with which the lens barrel 102 is rotated and driven in directions of the two axes. The angular velocity meter 106 and the accelerometer 107 respectively output an angular velocity detection signal and an acceleration detection signal. Vibration of the camera 101 is detected based on the output signals from the angular velocity meter 106 and the accelerometer 107, and rotation drive of the tilt rotation unit 104 and the pan rotation unit 105 is performed. With this configuration, vibration correction and inclination correction of the lens barrel 102 are performed. In addition, movement detection of the camera 101 is performed based on a measurement result over a certain period of time according to output signals of the angular velocity meter 106 and the accelerometer 107.

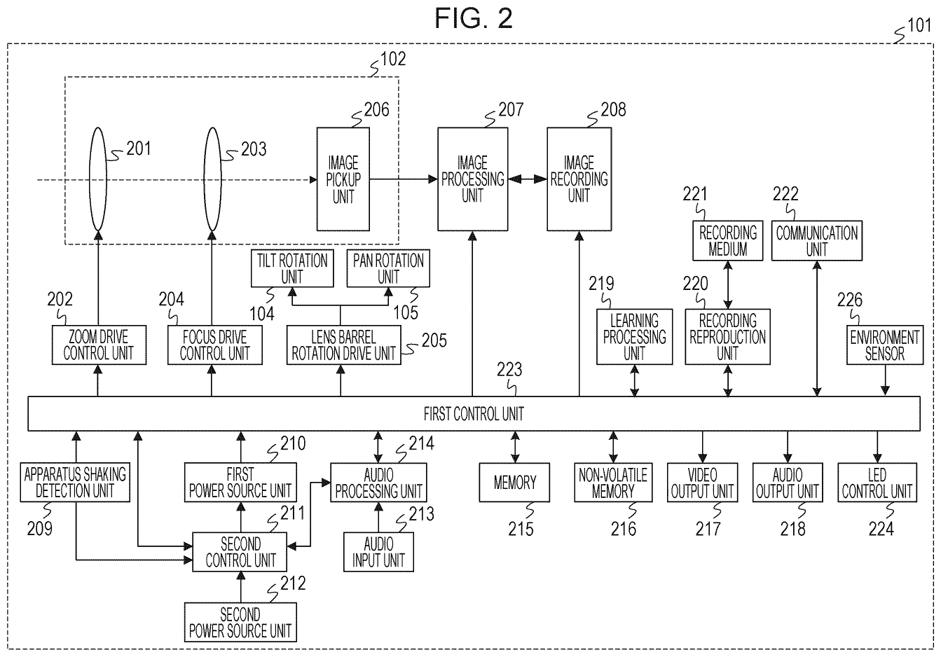

FIG. 2 is a block diagram illustrating a hardware configuration of the camera 101 according to the embodiment. A first control unit 223 includes a calculation processing unit. The calculation processing unit is a central processing unit (CPU), a micro processing unit (MPU), or the like. A memory 215 includes a dynamic random access memory (DRAM), a static random access memory (SRAM), or the like. The first control unit 223 executes various processes following a program stored in a non-volatile memory 216 (EEPROM) to control each block of the camera 101 and control data transfer between each block. The non-volatile memory 216 is an electrically erasable and rewritable memory and stores a constant for an operation of the first control unit 223, a program, and the like. A zoom unit 201 includes a zoom lens with which a magnification (enlargement or reduction of a formed subject image) is changed. A zoom drive control unit 202 drives and controls the zoom unit 201 and also detects a focal length at the time of drive control. A focus unit 203 includes a focus lens with which a focus is adjusted. A focus drive control unit 204 drives and controls the focus unit 203. An image pickup unit 206 includes an image pickup element. The image pickup unit 206 receives light incident through each lens group and outputs information of electric charges according to the amount of light as an analog image signal to an image processing unit 207. It is noted that the zoom unit 201, the focus unit 203, and the image pickup unit 206 are arranged in the lens barrel 102.

The image processing unit 207 performs image processing on digital image data obtained through analog-to-digital (A/D) conversion of the analog image signal. An example of the image processing includes a distortion correction, a white balance adjustment, color interpolation processing, or the like, and the image processing unit 207 outputs digital image data after the image processing. An image recording unit 208 obtains the digital image data output from the image processing unit 207. The digital image data is converted into a recording format such as a Joint Photographic Experts Group (JPEG) format. The data after the conversion is stored in the memory 215 and also transmitted to a video output unit 217 which will be described below.

A lens barrel rotation drive unit 205 drives the tilt rotation unit 104 and the pan rotation unit 105 to rotate the lens barrel 102 in the tilting direction and the panning direction. An apparatus shaking detection unit 209 includes the angular velocity meter 106 configured to detect an angular velocity in directions of the three axes of the camera 101 and the accelerometer 107 configured to detect an acceleration in directions of the three axes of the camera 101. The first control unit 223 calculates a rotation angle of the apparatus, a shift amount of the apparatus, and the like based on the detection signal received from the apparatus shaking detection unit 209.

An audio input unit 213 obtains an audio signal from the surrounding environment of the camera 101 by a microphone installed in the camera 101 and converts the audio signal into a digital audio signal to be transmitted to an audio processing unit 214. The audio processing unit 214 performs processing related to audio such as normalization processing of the input digital audio signal. The audio signal processed by the audio processing unit 214 is transmitted to the memory 215 by the first control unit 223. The memory 215 temporarily stores the image signal obtained by the image processing unit 207 and the audio signal obtained by the audio processing unit 214.

The image processing unit 207 and the audio processing unit 214 read out the image signal and the audio signal that have already been temporarily stored in the memory 215 and perform coding of the image signal, coding of the audio signal, and the like to generate a compressed image signal and a compressed audio signal. The first control unit 223 transmits the compressed image signal and the compressed audio signal after their generation to a recording reproduction unit 220.

The recording reproduction unit 220 records, in a recording medium 221, the compressed image signal generated by the image processing unit 207 and the compressed audio signal generated by the audio processing unit 214, control data related to image capturing, and the like. On the other hand, in a case where the audio signal is not compressed and encoded, the first control unit 223 transmits the audio signal generated by the audio processing unit 214 and the compressed image signal generated by the image processing unit 207 to the recording reproduction unit 220 to be recorded in the recording medium 221. The recording medium 221 is a recording medium built into the camera 101 or a detachable recording medium. The recording medium 221 can record various data such as the compressed image signal, the compressed audio signal, and the audio signal generated by the camera 101. In general, a medium having a capacity larger than that of the non-volatile memory 216 is used as the recording medium 221. For example, a recording medium of any type such as a hard disk, an optical disk, an opto-magnetic disk, a CD-R, a DVD-R, a magnetic tape, a non-volatile semiconductor memory, or a flash memory can be used as the recording medium 221.

The recording reproduction unit 220 reads out and reproduces the compressed image signal, the compressed audio signal, the audio signal, the various data, and the program recorded in the recording medium 221. The first control unit 223 respectively transmits the compressed image signal and the compressed audio signal that have been read out to the image processing unit 207 and the audio processing unit 214. The image processing unit 207 and the audio processing unit 214 cause the compressed image signal and the compressed audio signal to be temporarily stored in the memory 215, decode the signals in a predetermined procedure, and transmit the decoded signals to the video output unit 217.

A plurality of microphones are arranged in the audio input unit 213 of the camera 101. The audio processing unit 214 can detect a direction of audio with respect to a plane in which a plurality of microphones are installed, and detection information is used for a subject search, which will be described below, and the automatic image capturing. The audio processing unit 214 detects a specific audio command. The audio command includes, for example, some commands which have been registered in advance and a command, according to an embodiment in which the user can register specific audio in the camera, based on the registered audio. The audio processing unit 214 also performs audio scene recognition. In the audio scene recognition, audio scene determination processing is executed by a network in which machine learning has been performed in advance based on a large amount of audio data. For example, a neural network configured to detect a specific scene such as “cheers are erupting,” “people are clapping,” or “voices are being raised” is set in the audio processing unit 214, and the specific audio scene or the specific audio command is detected. When the specific audio scene or the specific audio command is detected, the audio processing unit 214 outputs a detection trigger signal to the first control unit 223 and a second control unit 211.

The second control unit 211 is provided separately from the first control unit 223 configured to control the entire camera system and controls a supply power source to the first control unit 223. A first power source unit 210 and a second power source unit 212 respectively supply electric power to operate the first control unit 223 and the second control unit 211. In response to a press of a power source button included in the camera 101, first, electric power is supplied to both the first control unit 223 and the second control unit 211. The first control unit 223 also performs control to turn OFF its own power source supply to the first power source unit 210. Even during a period in which the first control unit 223 does not operate, the second control unit 211 operates, and information from the apparatus shaking detection unit 209 and information from the audio processing unit 214 are input into the second control unit 211. The second control unit 211 determines, based on various input information, whether or not the first control unit 223 is to be activated. In a case where it is determined that the first control unit 223 is to be activated, the second control unit 211 instructs the first power source unit 210 to supply electric power to the first control unit 223.

An audio output unit 218 includes a speaker built into the camera 101 and outputs, for example, audio of a previously set pattern from the speaker at the time of image capturing or the like. An LED control unit 224 controls a light emitting diode (LED) provided in the camera 101. In addition, at the time of image capturing or the like, the LED control unit 224 controls the LED based on a lighting pattern and a flashing pattern that has been set in advance.

The video output unit 217 includes a video output terminal and outputs an image signal, for example, to cause a connected external display or the like to display video. It is noted that the audio output unit 218 and the video output unit 217 may be a single combined terminal such as, for example, a High-Definition Multimedia Interface (HDMI) (registered trademark) terminal.

A communication unit 222 is a processing unit configured to perform communication between the camera 101 and an external apparatus. For example, the communication unit 222 transmits and receives data such as the audio signal, the image signal, the compressed audio signal, or the compressed image signal. The communication unit 222 receives a control signal related to image capturing such as commands for image capturing start and end, and pan, tilt, and zoom drive, and outputs the control signal to the first control unit 223. With this configuration, the camera 101 can be driven based on the instruction from the external apparatus. The communication unit 222 also transmits and receives information such as various parameters related to learning processed by a learning processing unit 219 between the camera 101 and the external apparatus. The communication unit 222 includes a wireless communication module such as, for example, an infrared communication module, a Bluetooth (registered trademark) communication module, a wireless LAN communication module, a wireless USB (registered trademark), or a GPS receiver. An environment sensor 226 detects a state of a surrounding environment of the camera 101 in a predetermined period. The environment sensor 226 includes, for example, the sensors listed below:
a temperature sensor configured to detect a temperature in the surrounding environment of the camera 101;
a barometric pressure sensor configured to detect a barometric pressure in the surrounding environment of the camera 101;
an illuminance sensor configured to detect a brightness level in the surrounding environment of the camera 101;
a humidity sensor configured to detect a humidity in the surrounding environment of the camera 101; and
a UV sensor configured to detect an ultraviolet radiation level in the surrounding environment of the camera 101.

In addition to various detected information (temperature information, barometric pressure information, illuminance information, humidity information, UV information), a change rate at predetermined time intervals can be calculated based on the various information. In other words, a temperature change amount, a barometric pressure change amount, an illuminance change amount, a humidity change amount, and an ultraviolet radiation change amount can be used for the determination of the automatic image capturing or the like.

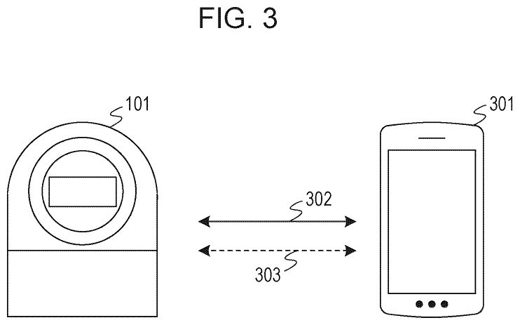

With reference to FIG. 3, communication between the camera 101 and an external apparatus 301 will be described. FIG. 3 illustrates a configuration example of a wireless communication system between the camera 101 and the external apparatus 301. The camera 101 is a digital camera having an image capturing function, and the external apparatus 301 is a smart device including a Bluetooth (registered trademark) communication module and a wireless LAN communication module.

In FIG. 3, the communication between the camera 101 and the external apparatus 301 is represented as a first communication 302 (solid line arrow) and a second communication 303 (dotted line arrow). For example, the first communication 302 is communication based on a wireless local area network (LAN) in compliance with an IEEE 802.11 standard series. The second communication 303 is, for example, communication implementing a master-subordinate relationship such as between a control station and a subordinate station like Bluetooth (registered trademark) Low Energy (hereinafter, which will be referred to as “BLE”). It is noted that the wireless LAN and BLE are examples of communication methods. Other communication methods may also be used as long as each communication apparatus has two or more communication functions, and in the master-subordinate relationship, by using one communication function with which communication is performed, control of the other communication function can be performed, for example. It is noted however that higher speed communication can be performed through the first communication 302 based on the wireless LAN or the like than the second communication 303 based on BLE or the like. In addition, the second communication 303 involves at least any one of lower power consumption or shorter communication availability distance than that of the first communication 302.

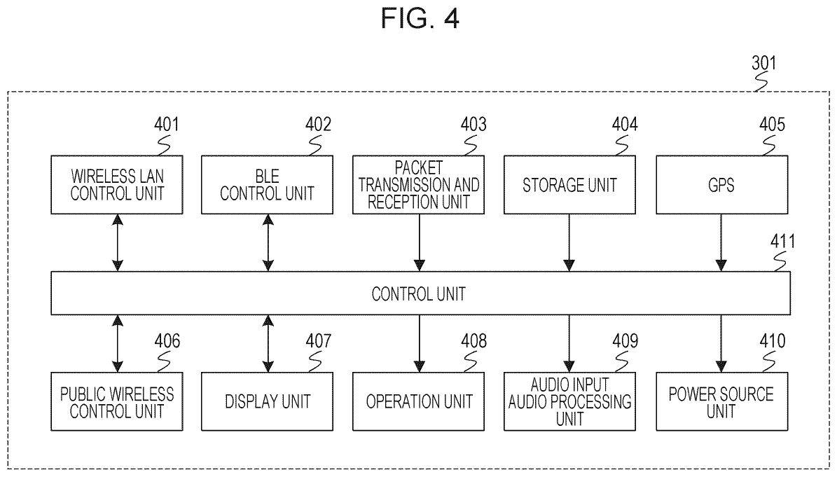

Next, with reference to FIG. 4, a configuration of the external apparatus 301 will be described. The external apparatus 301 includes, for example, a wireless LAN control unit 401 for wireless LAN, a BLE control unit 402 for BLE, and a public wireless control unit 406 for public wireless communication.

The wireless LAN control unit 401 performs radio frequency (RF) control of the wireless LAN communication, communication processing, driver processing of performing various types of control of the communication based on the wireless LAN in compliance with the IEEE 802.11 standard series, and protocol processing related to the communication based on the wireless LAN. The BLE control unit 402 performs RF control of BLE communication, communication processing, driver processing of performing various types of control of the communication based on BLE, and protocol processing related to the communication based on BLE. The public wireless control unit 406 performs RF control of public wireless communication, communication processing, driver processing of performing various types of control of the public wireless communication, and protocol processing related to the communication based on the public wireless communication. The public wireless communication is, for example, communication in compliance with International Multimedia Telecommunications (IMT) standards, Long Term Evolution (LTE) standards, or the like.

The external apparatus 301 further includes a packet transmission and reception unit 403. The packet transmission and reception unit 403 performs processing to execute at least any one of transmission and reception of packets related to the communication based on the wireless LAN, the communication based on BLE, or the public wireless communication. It is noted that descriptions will be provided where the external apparatus 301 according to the embodiment performs at least any one of transmission or reception of the packets in the communication, but other communication methods such as, for example, line exchange may also be used other than packet exchange. A control unit 411 included in the external apparatus 301 includes a CPU and the like and controls the external apparatus 301 by executing a control program stored in a storage unit 404. The storage unit 404 stores, for example, the control program executed by the control unit 411 and various information such as a parameter used for a communication. Various operations which will be described below are realized when the control program stored in the storage unit 404 is executed by the control unit 411.

A global positioning system (GPS) reception unit 405 receives a GPS signal transmitted from an artificial satellite and analyzes the GPS signal to estimate a current position (longitude and latitude information) of the external apparatus 301. Alternatively, an embodiment has been proposed in which by using a Wi-Fi positioning system (WPS) or the like, the current position of the external apparatus 301 is estimated based on information of a wireless network present in the surrounding environment. For example, cases where the current GPS position information obtained by the GPS reception unit 405 is located within a previously set position range (within a range within a predetermined radius centered on a detection location) and where a position change greater than or equal to a predetermined amount has occurred in the GPS position information are considered. In these cases, the camera 101 is notified of movement information via the BLE control unit 402, and the movement information is used as a parameter for the automatic image capturing or automatic editing. For example, a display unit 407 has a function of outputting visually recognizable information such as a liquid crystal display (LCD) or an LED or a function of outputting audio such as a speaker and presents various information. An operation unit 408 includes, for example, a button and the like configured to accept an operation of the external apparatus 301 by the user. It is noted that, for example, the display unit 407 and the operation unit 408 may include a touch panel or the like.

An audio input audio processing unit 409 obtains information concerning audio issued by a user via a general-purpose microphone built into the external apparatus 301, for example. The audio input audio processing unit 409 may be configured to identify an operation command issued by the user through audio recognition processing. In addition, a method of obtaining the audio command through a pronunciation by the user using a dedicated application in the external apparatus 301 has been proposed. In this case, a specific audio command for causing the audio processing unit 214 of the camera 101 to recognize the audio command can be registered via the first communication 302 based on wireless LAN. A power source unit 410 supplies electric power used by each unit in the external apparatus 301.

The camera 101 and the external apparatus 301 perform data transmission and reception by the communication using the wireless LAN control unit 401 and the BLE control unit 402. For example, transmission and reception of the data such as the audio signal, the image signal, the compressed audio signal, or the compressed image signal are performed. In addition, transmission of an image capturing instruction or the like from the external apparatus 301 to the camera 101, transmission of the audio command registration data, transmission of a predetermined position detection notification based on the GPS position information, transmission of a location movement notification, or the like is performed.

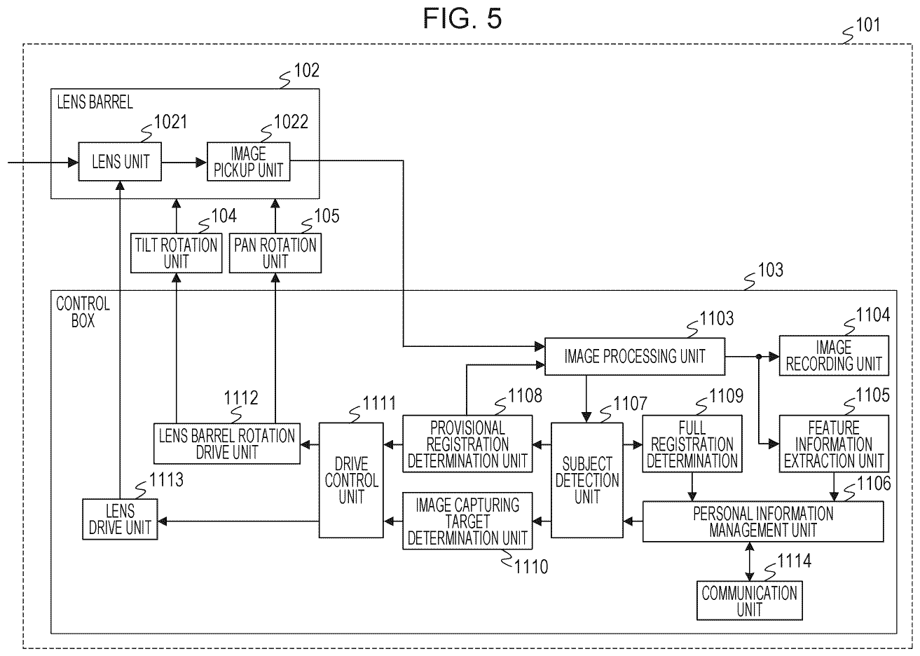

FIG. 5 is a block diagram illustrating the image pickup apparatus including the lens barrel 102, the tilt rotation unit 104, the pan rotation unit 105, and the control box (stationary part) 103. The control box (stationary part) 103 includes a microcomputer or the like configured to control the imaging lens group included in the lens barrel 102, the tilt rotation unit 104, and the pan rotation unit 105. The control box (stationary part) 103 is arranged in the image pickup apparatus. Even when panning drive or tilting drive of the lens barrel 102 is performed, the control box (stationary part) 103 is fixed.

The lens barrel 102 includes a lens unit 1021 constituting the image pickup optical system and an image pickup unit 1022 including an image pickup element. The lens barrel 102 is controlled to be respectively rotated and driven in the tilting direction and the panning direction by the tilt rotation unit 104 and the pan rotation unit 105. The lens unit 1021 includes a zoom lens with which a magnification is changed, a focus lens with which a focus adjustment is performed, and is the like and driven and controlled by a lens drive unit 1113 in the control box (stationary part) 103. A zoom mechanism unit includes the zoom lens and the lens drive unit 1113 configured to drive the lens. When the zoom lens moves in an optical axis direction by the lens drive unit 1113, a zoom function is realized.

The image pickup unit 1022 includes the image pickup element and receives light incident through each lens group including the lens unit 1021 to output information of electric charges according to the light amount as digital image data to an image processing unit 1103. The tilt rotation unit 104 and the pan rotation unit 105 rotate and drive the lens barrel 102 by a drive instruction output from the lens barrel rotation drive unit 1112 in the control box (stationary part) 103. Next, a configuration in the control box (stationary part) 103 will be described. An image capturing direction for automatic image capturing is controlled by a provisional registration determination unit 1108, an image capturing target determination unit 1110, a drive control unit 1111, and a lens barrel rotation drive unit 1112.

The image processing unit 1103 obtains the digital image data output from the image pickup unit 1022. Image processing such as a distortion correction, a white balance adjustment, or color interpolation processing is applied to the obtained digital image data. The digital image data after the image processing application is output to an image recording unit 1104 and a subject detection unit 1107. In addition, the image processing unit 1103 outputs the digital image data to a feature information extraction unit 1105 in response to an instruction from the provisional registration determination unit 1108.

The image recording unit 1104 converts the digital image data output from the image processing unit 1103 into a recording format such as the JPEG format to be stored in a recording medium (such as a non-volatile memory). The feature information extraction unit 1105 obtains an image of a face located at a center of the digital image data output from the image processing unit 1103. The feature information extraction unit 1105 extracts feature information from the obtained face image and outputs the face image and the feature information to a personal information management unit 1106. The feature information refers to information indicating a plurality of face feature points located in sites such as eyes, a nose, and a mouth of a face and is used for a personal discrimination of the detected subject. The feature information may be other information indicating features of the face such as a contour of the face, color information of the face, and depth information of the face.

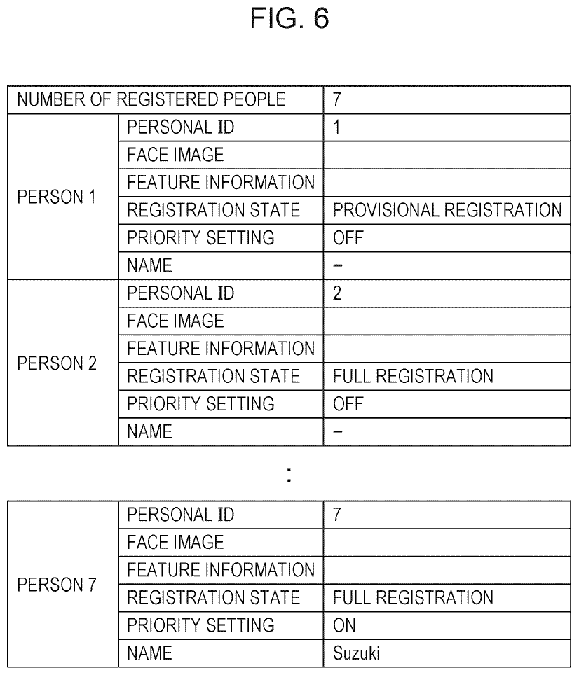

The personal information management unit 1106 performs processing of storing and managing personal information linked to each person in the storage unit. With reference to FIG. 6, an example of the personal information will be described. The personal information includes a personal ID, a face image, feature information, a registration state, a priority setting, and a name. The personal ID is identification information (ID) for identifying a plurality of pieces of the personal information, and a unique ID is not issued more than once. A value greater than or equal to 1 is set as the ID. Face image data is data of the face image input by the feature information extraction unit 1105. The feature information is information input by the feature information extraction unit 1105. With regard to the registration state, two states including “provisional registration” and “full registration” are defined. The “provisional registration” indicates a state in which it is determined by a provisional registration determination that there is a possibility that a subject is a key person. The “full registration” indicates a state in which it is determined by a full registration determination, or depending on the presence or absence of a user operation, that the subject is a key person. Details of the processing of the provisional registration determination and the full registration determination will be described below. The priority setting is a setting by a user operation indicating whether or not image capturing is performed by priority. The name is a name assigned by a user operation to each person.

When the face image and the feature information are obtained from the feature information extraction unit 1105, the personal information management unit 1106 newly issues a personal ID, and links the personal ID, the input face image, and the feature information, and newly adds the personal information. An initial value of the registration state is set to “provisional registration,” an initial value of the priority setting is set to “off,” and an initial value of the name is left blank when the personal information is newly added. When a full registration determination result (personal ID that should be fully registered) is obtained by a full registration determination unit 1109, the personal information management unit 1106 changes the registration state of the personal information corresponding to the personal ID to “full registration.” In addition, in a case where a change instruction of the personal information (the priority setting or the name) from a communication unit 1114 is input by a user operation, the personal information management unit 1106 changes the personal information following the instruction. Moreover, in a case where a change in either the priority setting or the name occurs for a person having the registration state of “provisional registration,” the personal information management unit 1106 determines that the person is a key person and changes the registration state of the person to “full registration.”

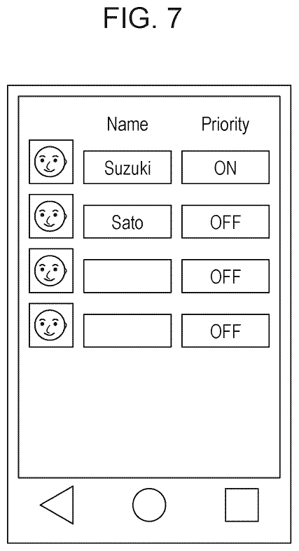

FIG. 7 is a schematic diagram illustrating an example of a screen of a mobile terminal apparatus (external apparatus 301) configured to communicate with the camera 101. The mobile terminal apparatus obtains personal information via the communication unit 1114 of the camera 101 and displays the personal information in a list format on the screen. In the example illustrated in FIG. 7, the face image, the name, and the priority setting are displayed on the screen. With regard to the name and the priority setting, a change can be made by the user. In a case where the name or the priority setting is changed, the mobile terminal apparatus outputs a change instruction of the name or the priority setting linked to the personal ID to the communication unit 1114.

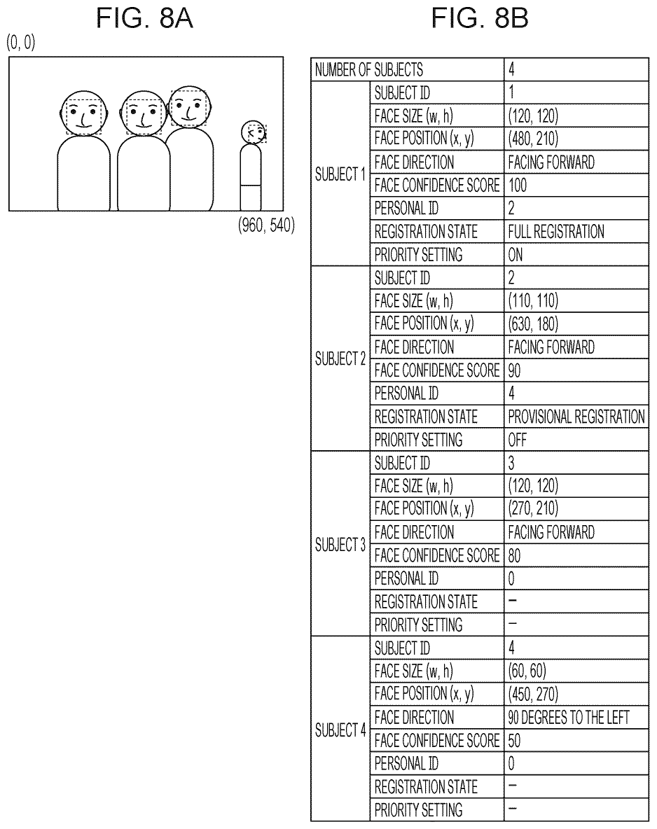

The subject detection unit 1107 in FIG. 5 performs subject detection from the digital image data output from the image processing unit 1103 and extracts information (subject information) of a detected subject. An example in which the subject detection unit 1107 detects a face of a person as a subject will be illustrated. The subject information refers to, for example, the number of detected subjects, a face position, a face size, a face direction, a face confidence score indicating a detection confidence, and the like. The subject detection unit 1107 also calculates a degree of similarity by collating the feature information of each person obtained by the personal information management unit 1106 with the feature information of the detected subject. In a case where the degree of similarity is greater than or equal to a threshold, processing of adding the personal ID, the registration state, and the priority setting of the detected person to the subject information is executed. The subject detection unit 1107 outputs the subject information to the provisional registration determination unit 1108, the full registration determination unit 1109, and the image capturing target determination unit 1110. Examples of the subject information will be described below with reference to FIG. 8A and FIG. 8B.

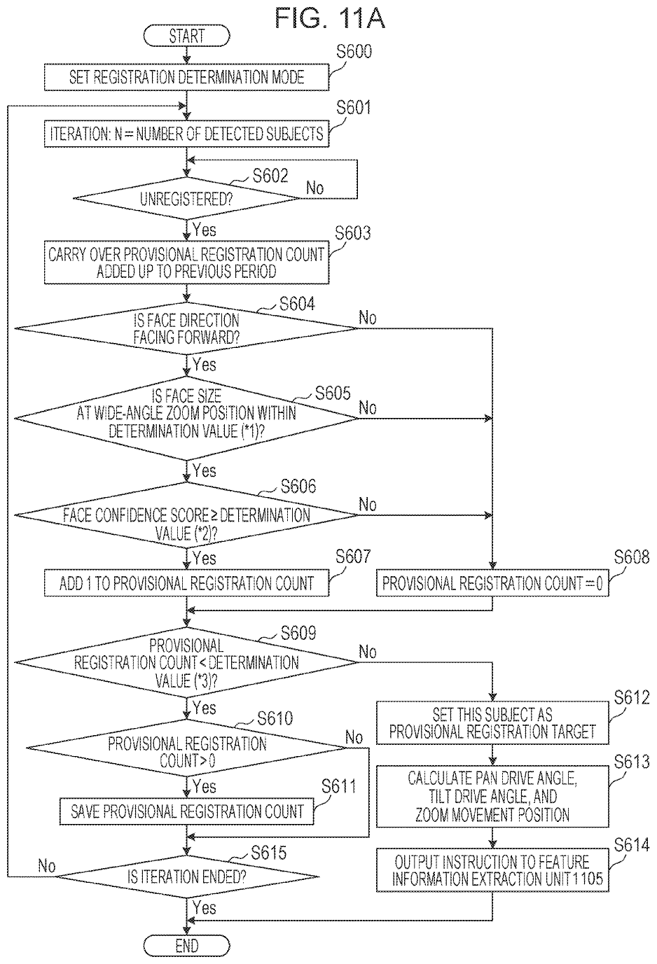

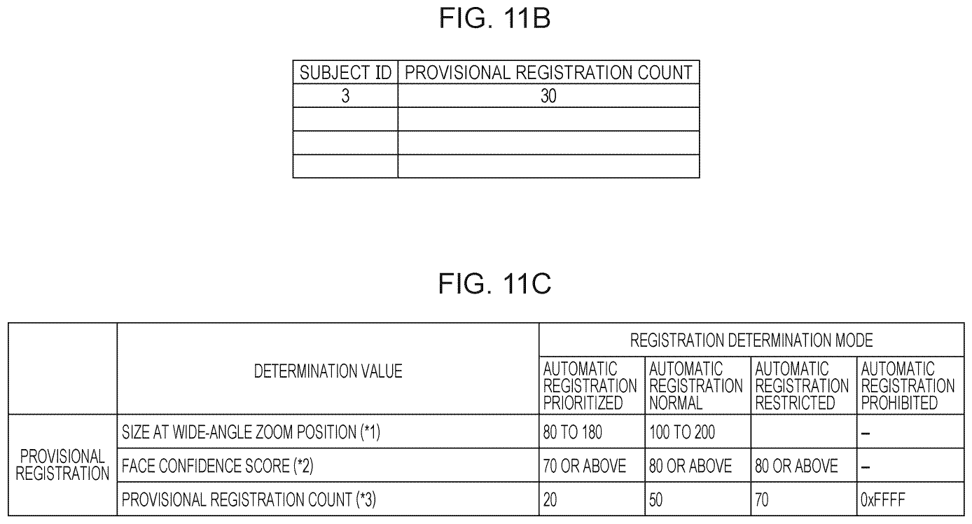

The provisional registration determination unit 1108 determines whether or not there is a possibility that the subject detected by the subject detection unit 1107 is a key person, that is, the subject should be provisionally registered. In a case where it is determined that any of the subjects is a person who should be provisionally registered, the provisional registration determination unit 1108 calculates a panning drive angle, a tilting drive angle, and a target zoom position used to arrange the person who should be provisionally registered at a center of the screen with a designated size. A command signal based on a calculation result is output to the drive control unit 1111. Details of provisional registration determination processing will be described below with reference to FIGS. 11A through 11C.

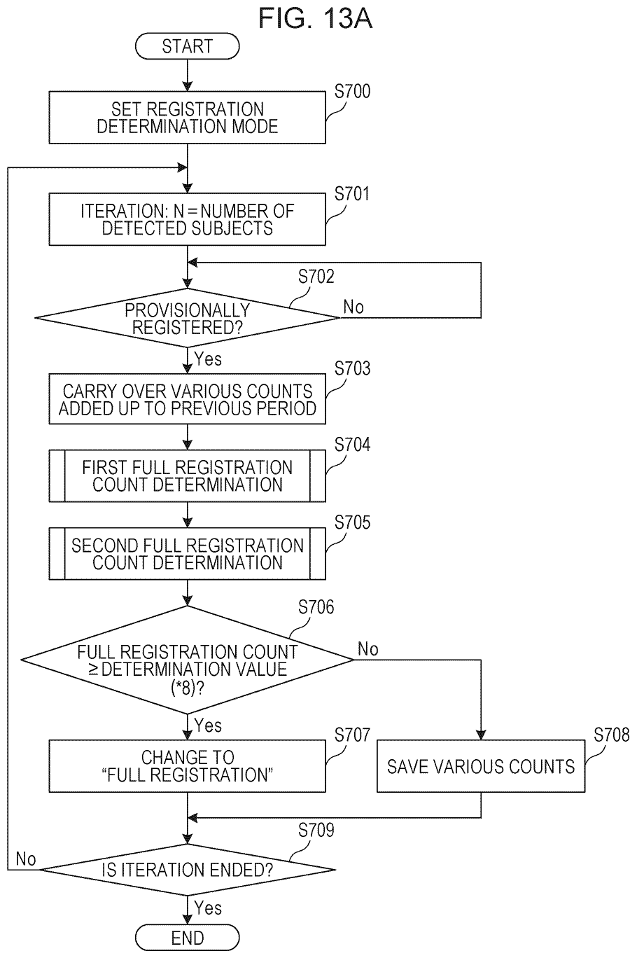

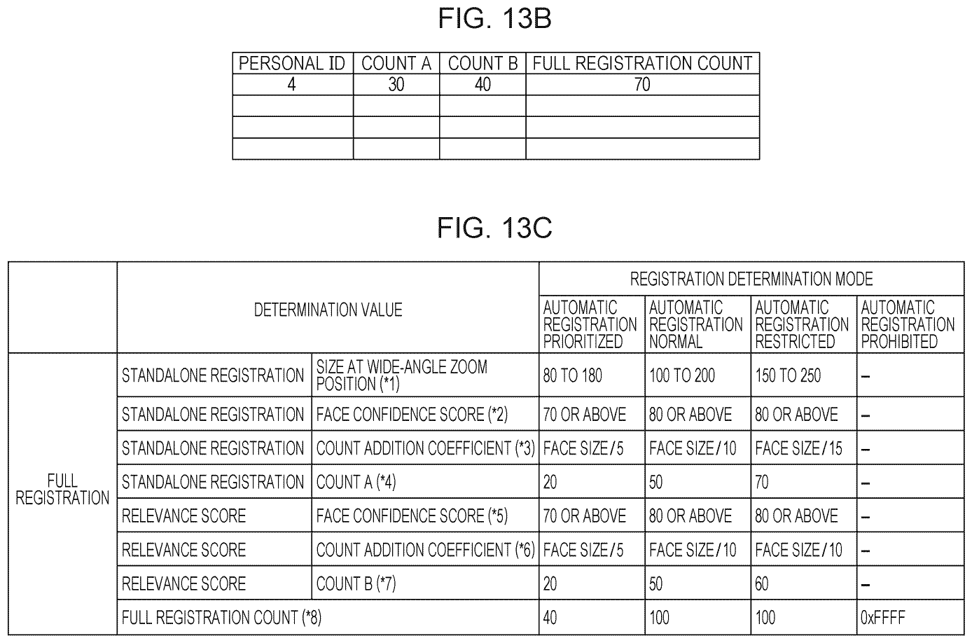

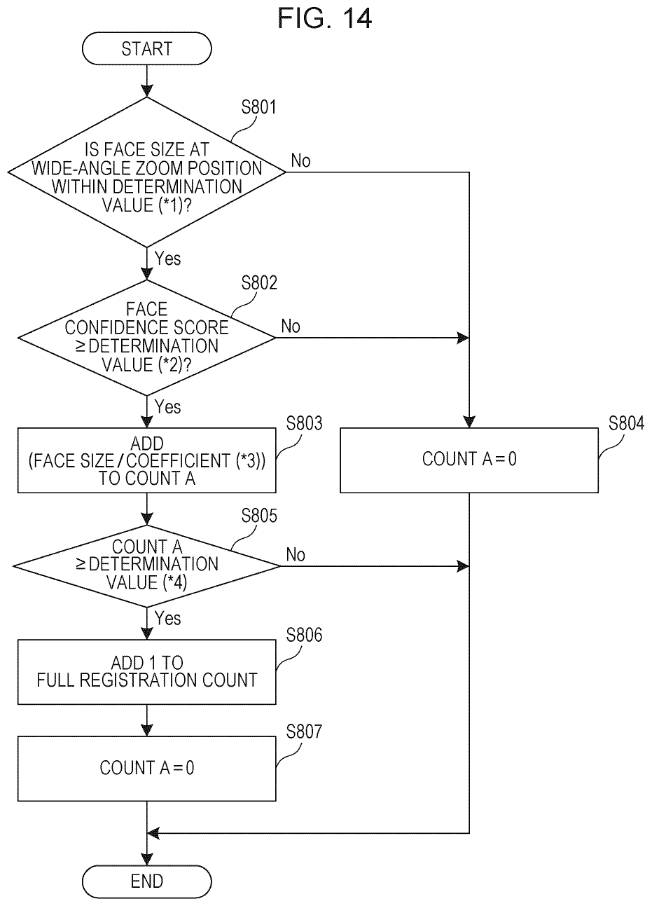

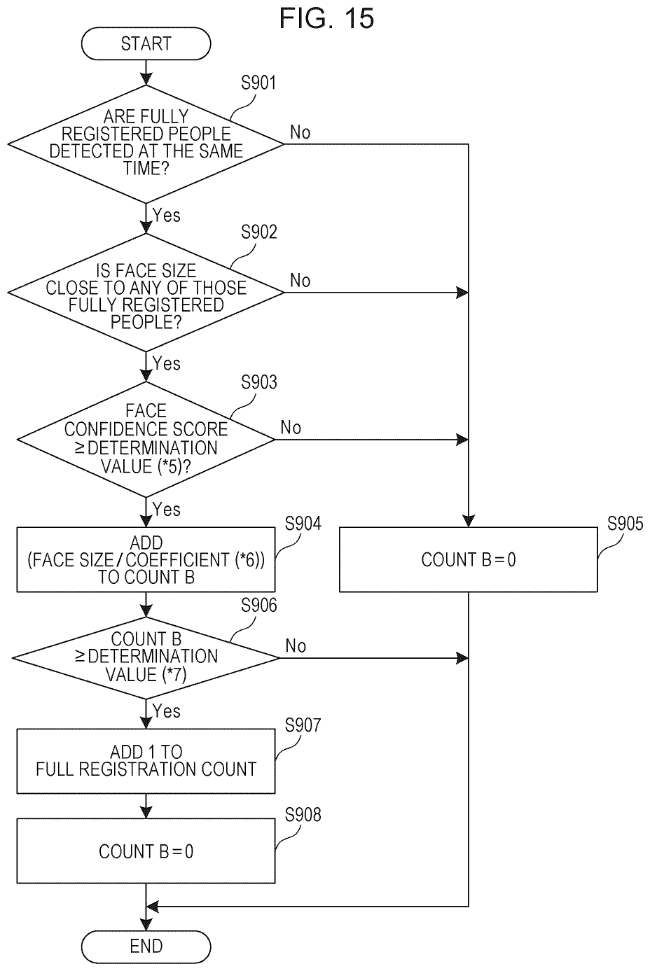

The full registration determination unit 1109 determines a person associated with the user, that is, a person who should be fully registered based on the subject information obtained from the subject detection unit 1107. In a case where it is determined that any of the subjects is a person who should be fully registered, the personal ID of the person who should be fully registered is output to the personal information management unit 1106. Details of full registration determination processing will be described below with reference to FIGS. 13A through 13C, FIG. 14, and FIG. 15.

The image capturing target determination unit 1110 determines, based on the subject information obtained from the subject detection unit 1107, a subject set as the image capturing target. The image capturing target determination unit 1110 further calculates, based on a determination result on the person who should be set as the image capturing target, a panning drive angle, a tilting drive angle, and a target zoom position to fit the person who should be set as the image capturing target within the angle of view at a designated size. The command signal based on the calculation result is output to the drive control unit 1111.

When an instruction signal from the provisional registration determination unit 1108 or the image capturing target determination unit 1110 is obtained, the drive control unit 1111 outputs information of a control parameter to the lens drive unit 1113 and the lens barrel rotation drive unit 1112. A parameter based on the target zoom position is output to the lens drive unit 1113. A parameter corresponding to a target position based on the panning drive angle and the tilting drive angle is output to the lens barrel rotation drive unit 1112.

In a case where an input from the provisional registration determination unit 1108 exists, the drive control unit 1111 decides, based on the input value from the provisional registration determination unit 1108, each target position (the target zoom position and the target position based on the above-described drive angles) without referring to the input from the image capturing target determination unit 1110. The lens barrel rotation drive unit 1112 outputs drive instructions to the tilt rotation unit 104 and the pan rotation unit 105 based on the target position and a drive speed from the drive control unit 1111. The lens drive unit 1113 includes motors and driver units configured to drive the zoom lens, the focus lens, and the like constituting the lens unit 1021. The lens drive unit 1113 drives each lens based on the target position from the drive control unit 1111.

The communication unit 1114 transmits the personal information stored in the personal information management unit 1106 to an external apparatus 301 such as a mobile terminal apparatus. In addition, when a change instruction of the personal information from the external apparatus 301 is received, the communication unit 1114 outputs an instruction signal to the personal information management unit 1106. According to the embodiment, the change instruction from the external apparatus 301 is a change instruction with regard to the priority setting or the name of the personal information.

FIG. 8A illustrates an example of image data, and FIG. 8B is a table illustrating an example of the subject information obtained by the subject detection unit 1107. FIG. 8A is a schematic diagram illustrating an example of image data input into the subject detection unit 1107. For example, the image data is configured by a horizontal resolution of 960 pixels and a vertical resolution of 540 pixels. FIG. 8B is a table illustrating an example of the subject information extracted in a case where data of the image illustrated in FIG. 8A is input into the subject detection unit 1107. The exemplified subject information includes the number of subjects and, for each subject, a subject ID, a face size, a face position, a face direction, a face confidence score, the personal ID, the registration state, and the priority setting.

The number of subjects indicates the number of detected faces. In the example of FIG. 8B, the number of subjects is 4 and the face size, the face position, the face direction, the face confidence score, the personal ID, the registration state, and the priority setting for each of the four subjects are included. The subject ID is a numerical value for identifying a subject and is issued when a subject is newly detected. The same subject ID is not issued for more than one subject, and the subject ID is issued using a new value each time a subject is detected. For example, in a case where a specific subject is no longer detected once the subject moves out of the angle of view and thereafter the subject returns to be in the angle of view and is detected again, another value for the subject ID is newly issued even for the same subject.

The face size (w, h) includes numerical values indicating a size of the detected face, in which the number of pixels for a width (w) and the number of pixels for a height (h) of the face are input. According to the embodiment, the width and the height are assumed to be the same value.

The face position (x, y) includes numerical values indicating a relative position of the detected face in an image capturing range. In a case where an upper left corner of the image data is defined as a start point (0, 0) and a lower right corner of the image data is defined as an end point (960, 540), the number of horizontal pixels and the number of vertical pixels from the start point to central coordinates of the face are input. The face direction is information indicating a detected face direction, and any of information is input among facing forward, 45 degrees to the right, 90 degrees to the right, 45 degrees to the left, 90 degrees to the left, or unknown. The face confidence score is information indicating a confidence, or a degree of certainty, of the face of the detected person, in which any value from 0 to 100 is input. The face confidence score is calculated based on a degree of similarity with respect to feature information of a plurality of previously stored standard face templates.

The personal ID is the same as the personal ID managed by the personal information management unit 1106. When a subject is detected, the subject detection unit 1107 calculates a degree of similarity between the feature information of each person that is obtained by the personal information management unit 1106 and the feature information of the subject. The personal ID of the person having the degree of similarity greater than or equal to the threshold is input. In a case where the feature information is not similar to that of any person obtained by the personal information management unit 1106, zero is input as the personal ID value. The information of the registration state and the priority setting is the same as the information of the registration state and the priority setting managed by the personal information management unit 1106. In a case where the personal ID is not zero, that is, a case where it is determined that the person is any of the people managed by the personal information management unit 1106, the information of the registration state and the priority setting of the person obtained by the personal information management unit 1106 is input.

In the automatic image capturing, by designating that tracking and image capturing are performed for the registered person by priority, image capturing that focuses on the person (priority person) can be performed. In a case where the priority person is not detected, a case where although the priority person is detected, the person is not recognized as the priority person, or the like, it is also desired that the key person is to be captured as much as possible. In addition, even in a case where the priority person is detected, when other key people such as family members and friends are detected at the same time, the control based on detection of the priority person, which realizes such control that those key people are also caused to be fit within the angle of view and unrelated people are not to be within the angle of view as much as possible, is originally based on a premise that the registered person is the subject desired by the user. Therefore, it is important to appropriately perform the automatic authentication registration.

According to the embodiment, in the image pickup apparatus in which the automatic image capturing and the automatic authentication registration are performed, control for performing appropriate automatic authentication registration according to a scene will be hereinafter described.

### First Embodiment

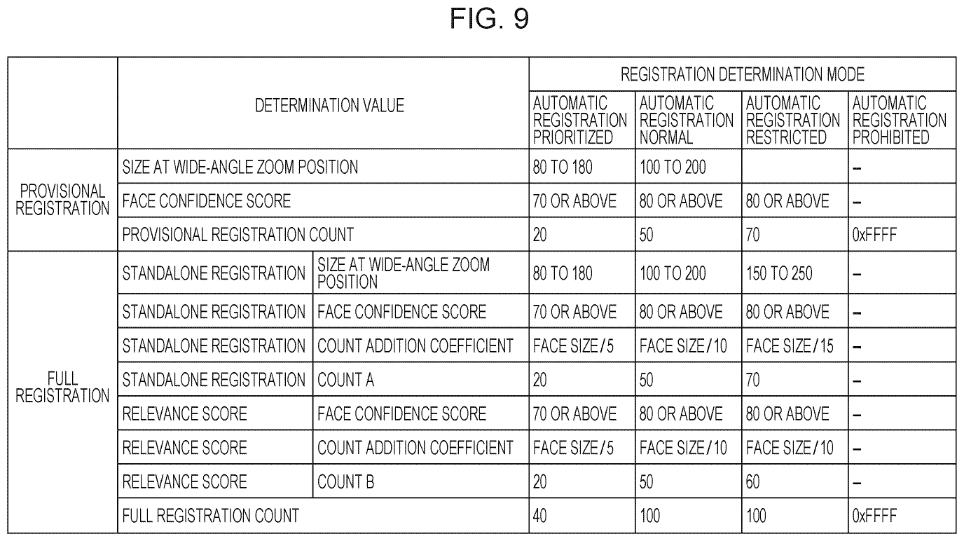

FIG. 9 is a table illustrating a condition for adding a registration count and a determination value for the registration count for each registration determination mode.

An automatic registration priority mode is set in a case where the automatic authentication registration is desired to be successively performed in a short period of time while people nearby are basically people who should be registered, in other words, there are a large number of unregistered people who are acquaintances and the like.

In a case where the size of the subject is small at a wide-angle zoom position, in other words, a subject is slightly far from the camera, the determination value is set such that the registration is facilitated while the face confidence score is set to be slightly on a lower side, and the registration count is set to be on a lower side. With this configuration, based on a premise that a person close to the camera is a person desired by the user to be registered, the automatic registration is facilitated.

An automatic registration prohibition mode is set such that the automatic registration is not performed at all.

An automatic registration normal mode is a mode in which even in a situation where a scene or a circumstance is not identified, the automatic registration is performed in a balanced manner.

An automatic registration restriction mode is used in an environment with an unspecified and large number of people or the like. The determination value is basically set such that the registration is less likely to be performed, and the determination value for information of a subject registered standalone is set to be on a strict side.

However, in the environment with the unspecified and large number of people, with regard to the relevance of the fully registered person, the person is likely to be an acquaintance, and therefore the determination value is not set to be that strict.

In the present example, the number of modes is set to three, but three or more modes may be prepared.

In the subsequent registration processing, the processing is performed by referring to each registration determination mode and determination value, but the basic registration processing will be described by using an example in which the determination mode is a normal case.

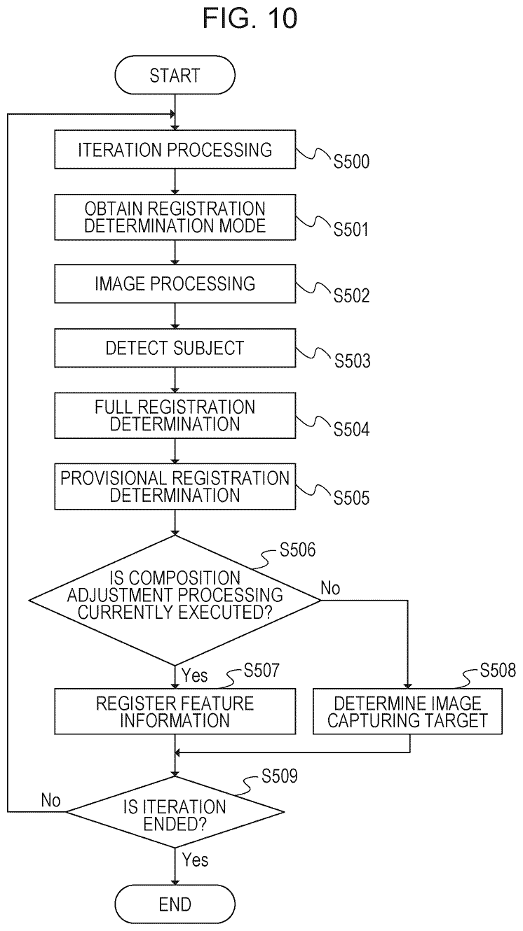

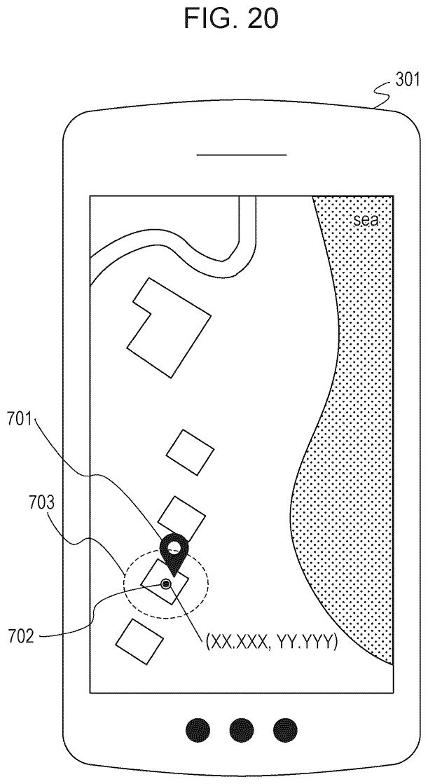

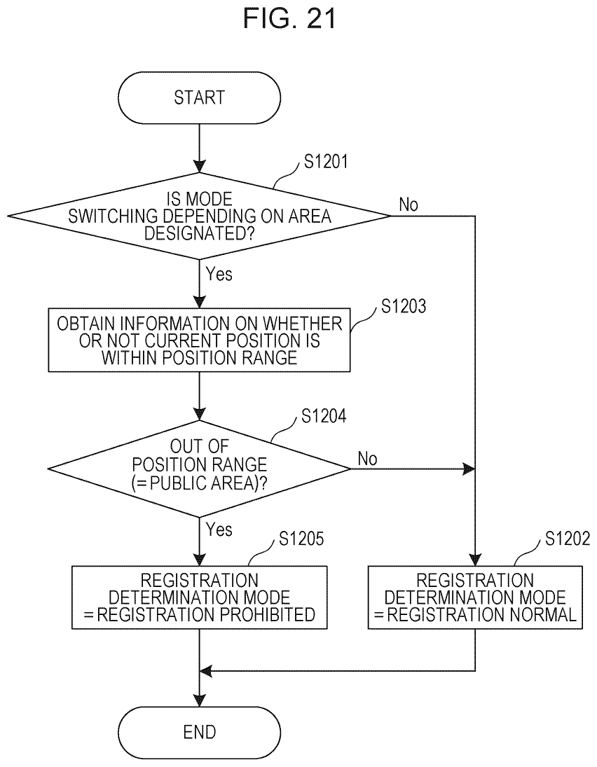

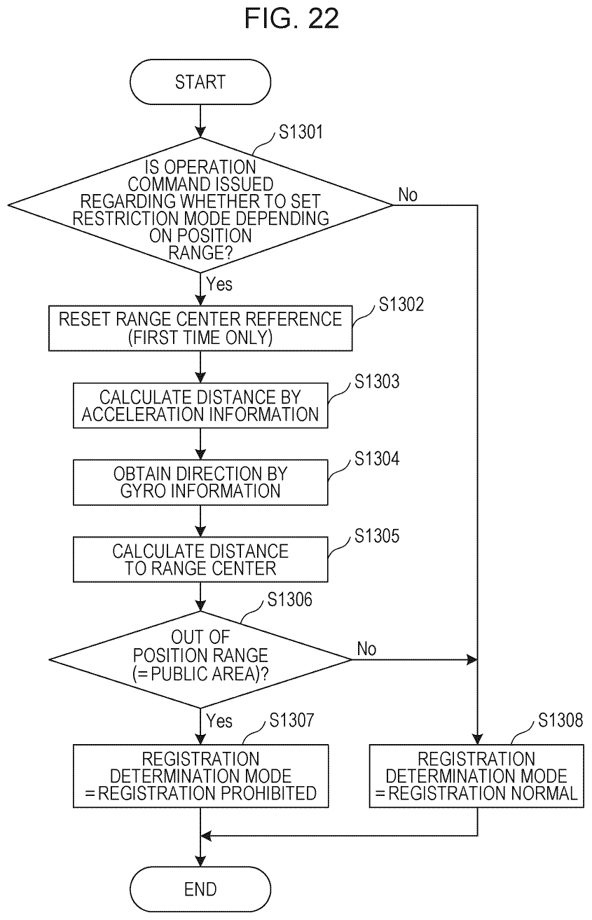

The processing for the registration determination using the determination value in the table of FIG. 9 will be described with reference to FIG. 10, FIGS. 11A through 11C, FIGS. 13A through 13C, FIG. 14, and FIG. 15. In addition, a method of switching the above-described registration modes will be described with reference to FIG. 19, FIG. 20, FIG. 21, and FIG. 22.

With reference to FIG. 10, according to the present embodiment, processing that is periodically executed will be described. FIG. 10 is a flowchart illustrating an overall flow of image capturing and registration and updating of the personal information. When the power source of the image pickup apparatus is turned ON, the image pickup unit 1022 of the image pickup apparatus starts periodical image capturing (movie shooting) to obtain image data used in various determinations (the image capturing target determination, the provisional registration determination, and the full registration determination). In S500, iteration processing is started. It is noted that unless otherwise specified, each step in the flow of FIG. 10 is executed in each unit of the camera 101 by the first control unit 223 or in response to an instruction from the first control unit 223.

In S501, a mode used in the subsequent registration determination is obtained.

Image data obtained through image capturing is output to the image processing unit 1103, and in S502, the image data to which various image processes are applied are obtained. Because the obtained image data is image data for various determinations, this image data is output from the image processing unit 1103 to the subject detection unit 1107. In other words, the image data obtained herein corresponds to image data for live view display in the image pickup apparatus configured to capture an image while the user performs a composition adjustment and a shutter operation, and periodical image capturing to obtain this image data corresponds to live view image capturing. The control box (stationary part) 103 performs the composition adjustment and a determination on an automatic image capturing timing by using the obtained image data.

Next, in S503, the subject detection unit 1107 performs the subject detection based on the image data and obtains the subject information (see FIG. 8B). After the subject is detected and the subject information is obtained, the full registration determination is performed in S504. In the full registration determination, the determination on the person who should be fully registered is performed according to the registration determination mode obtained in S501 by using information of the detected subject. In this determination, the personal information of the personal information management unit 1106 is updated, but the panning drive, the tilting drive, and the zoom drive are not executed.

In S505, the provisional registration determination is performed. In the provisional registration determination, among the detected subjects, provisional registration processing according to the registration determination mode obtained in S501 is performed, and the subject who should be provisionally registered is decided to obtain the panning drive angle and the tilting drive angle based on the face position of the subject who should be provisionally registered. In addition, the target zoom position is obtained based on the position and the size of the face. The provisional registration determination unit 1108 instructs the image processing unit 1103 to output the image data to the feature information extraction unit 1105. In the provisional registration determination, when the panning drive angle, the tilting drive angle, and the target zoom position are obtained, because the panning drive, the tilting drive, and the zoom drive are executed based on these pieces of information, a composition for a provisional registration is adjusted.

After the processing in S505, the flow proceeds to S506, and it is determined whether or not composition adjustment processing for the provisional registration is currently executed. In S506, in a case where the composition adjustment processing for the provisional registration is executed, the flow shifts to S507. In a case where the composition adjustment processing for the provisional registration is not executed, the flow shifts to S508.

In S507, the feature information extraction unit 1105 extracts feature information of the subject located at the center of the image data and outputs the extracted feature information to the personal information management unit 1106. In addition, in S508, the image capturing target determination is executed. The image capturing target determination unit 1110 decides a subject set as the image capturing target among the detected subjects. The panning drive angle and the tilting drive angle are obtained based on the face position of the subject set as the image capturing target. In addition, the target zoom position is obtained based on the position and the size of the face. When the panning drive angle, the tilting drive angle, and the target zoom position are obtained by the image capturing target determination, the panning drive, the tilting drive, and the zoom drive are executed based on these pieces of information, and the image capturing composition is adjusted.

It is noted that a description on details of the image capturing target determination is omitted because the image capturing target determination is not directly related to the gist of the present disclosure. After S507 or S508, the flow proceeds to S509, and a determination on the end of the iteration processing is performed. In a case where the processing continues, the flow returns to S500, and the processing continues. The processing illustrated in S502 to S508 is repeatedly executed in accordance with an image pickup period of the image pickup unit 1022.

### Provisional Registration Processing

With reference to FIGS. 11A through 11C, the provisional registration determination processing illustrated in S505 of FIG. 10 will be described. FIG. 11A is a flowchart for describing the provisional registration determination processing performed by the provisional registration determination unit 1108.

The present processing is periodically executed, and a determination is performed on whether or not there is a possibility that the subject is a key person. It is noted that unless otherwise specified, each step in the flow of FIG. 11A is executed by the first control unit 223 or each unit of the camera 101 according to an instruction from the first control unit 223.

FIG. 11B is a table illustrating the provisional registration count. The provisional registration count is linked to the subject ID, and in a case where the provisional registration count becomes greater than or equal to the determination value, the relevant subject is determined to be a provisional registration target person. Because the provisional registration determination is executed over a plurality of periods, processing is performed such that the current provisional registration count is stored at the time of the determination in the current period, and in the next period, a reference is made to the provisional registration count obtained by accumulating the count added up to the previous period, and the accumulated count is carried over.

FIG. 11C is a table obtained by extracting only provisionally registered parts with regard to FIG. 9.

In S600, the determination mode obtained in S501 is set. With this configuration, the subsequent various determination values are switched. The determination values in the subsequent processing will be described by using an example in which the registration determination mode is basically a normal case.

In S601, iteration processing corresponding to the number of detected subjects is started. When the subject information is obtained from the subject detection unit 1107, the provisional registration determination unit 1108 executes the processing in S602 to S610 on each subject, and when any of the subjects is determined to be the provisional registration target, the provisional registration determination unit 1108 executes the processing in S611 to S614. In S602, processing of determining whether the subject is unregistered is executed. The provisional registration determination unit 1108 refers to the personal ID in the subject information, and in a case where it is determined that the subject is in an unregistered state (where the personal ID is zero), the flow shifts to the processing in S603. On the other hand, in a case where it is determined that the value of the personal ID is greater than or equal to 1, that is, the subject is already registered, the flow proceeds to the determination processing for the next subject.

In S603, a reference is made to the saved provisional registration count up to the previous frame, and in a case where the provisional registration count of the same subject ID exists, the provisional registration determination unit 1108 carries over the provisional registration count. Next, in S604, the provisional registration determination unit 1108 determines whether or not the face direction is facing forward. In a case where it is determined that the face direction is facing forward, the flow proceeds to the processing in S605, and in a case where it is determined that the face direction is not facing forward, the flow proceeds to the processing in S608.

S605 is processing of determining whether or not the face size at the wide-angle zoom position is within a range from 100 to 200. It is noted that this value is variable according to the registration determination mode. In a case where this condition is met, the flow proceeds to the processing in S606, and in a case where the condition is not met, the flow proceeds to S608. S606 is processing of determining whether or not the face confidence score is greater than or equal to the threshold of 80. It is noted that this value is variable according to the registration determination mode. In a case where this condition is met, the flow proceeds to the processing in S607, and in a case where the condition is not met, the flow proceeds to S608.

In a case where all the conditions illustrated in S604 to S606 are met, the flow proceeds to the processing in S607.

In S607, the provisional registration determination unit 1108 determines that there is a possibility that the target person is a key person associated with the user and adds (increments) 1 to the provisional registration count. On the other hand, in a case where any one of the respective conditions illustrated in S604 to S606 is not met, the flow proceeds to the processing in S608. In S608, the provisional registration determination unit 1108 determines that the possibility that the target person is a key person is low and sets the provisional registration count to zero.

After the processing in S607 or S608, in S609, the provisional registration determination unit 1108 compares the value of the provisional registration count of the subject with the threshold of 50. It is noted that this value is variable according to the registration determination mode. In a case where it is determined that the value of the provisional registration count is less than 50, the flow proceeds to S 610. On the other hand, in a case where it is determined that the value of the provisional registration count is greater than or equal to 50, the flow shifts to S 612.

In S610, the provisional registration determination unit 1108 determines whether or not the value of the provisional registration count is greater than zero. In a case where it is determined that the value of the provisional registration count is greater than zero, the flow shifts to S611. In a case where the condition is not met (the value of the provisional registration count is zero), the provisional registration count is not saved, and the flow shifts to S615. In addition, in S611, the provisional registration determination unit 1108 saves the provisional registration count, and the flow then proceeds to the determination processing in S615. In S615, the determination on the end of the iteration processing is performed. In a case where the processing continues, the flow returns to S601, and the flow shifts to the determination processing for the next subject.

In S612, the provisional registration determination unit 1108 determines that there is a possibility that the subject is a key person and sets the subject as a provisional registration target. In S613, the provisional registration determination unit 1108 calculates a panning drive angle, a tilting drive angle, and a zoom movement position such that the face of the subject of the provisional registration target is arranged at the center of the screen with an appropriate face size and outputs a command based on the calculation result to the drive control unit 1111. For example, it is configured that the feature information can be obtained in the feature information extraction unit 1105 in a case where a center position of the face falls within a 5% margin of the screen center and the face size becomes 100 to 200.

According to the present embodiment, to obtain the feature information, control is performed such that the subject set as the image capturing target is arranged at the screen center. The method is not limited to this, and the feature information may be extracted by performing image processing of cutting out part of the image data including the face of the target subject or the like without changing the position of the subject. In S614, the provisional registration determination unit 1108 instructs the image processing unit 1103 to output the image data to the feature information extraction unit 1105. The feature information extraction unit 1105 cuts out a face image located at the center of the input image data and extracts feature information to output the face image and the feature information to the personal information management unit 1106. The personal information management unit 1106 newly adds the personal information based on the face image and the feature information that are input. After the processing in S614, the series of processes is ended.

For a zoom position in the image pickup apparatus according to the present embodiment, it is possible to set a value from 0 to 100.

The zoom position means that as the value is smaller, the angle is on the wider side, and the value is larger, the angle is on the more telephoto side. That is, a wide-angle zoom position illustrated in S605 means a state in which the zoom position is zero, and the angle of view is the widest. In the image pickup apparatus, when the face size at the wide-angle zoom position is 100 to 200, it is determined that a distance between the subject and the image pickup apparatus can be predicted to be approximately 50 cm to 150 cm. In other words, in a case where the subject is located at a distance that is not too close to, and not too far from, the image pickup apparatus, it is determined that there is a possibility that the subject is a key person. In the examples of FIGS. 11A through 11C, the processing of calculating the distance between the subject and the image pickup apparatus based on the face size has been described, but the distance to the subject may be measured by other methods using a depth sensor, a compound lens, or the like.

Subsequently, a specific example of the provisional registration determination in a case where the subject information illustrated in FIG. 8B is input will be described. It is noted that here, the zoom position is set as zero. Because each of a subject 1 and a subject 2 in FIG. 8B is already registered in S602 of FIG. 11A (the personal ID is not zero), the processing in S603 and subsequent steps is not executed.

Because a subject 3 in FIG. 8B has the personal ID of zero (unregistered) in S602 of FIG. 11A, the processing in S603 and subsequent steps is executed. As illustrated in FIG. 11B, the provisional registration count of the subject ID of 3 up to the previous period is 30. In S 603 of FIG. 11A, a reference is made to the provisional registration count up to the previous period, and in a case where the provisional registration count of the subject ID of 3 exists, the information is carried over. Because the face direction of the subject 3 in FIG. 8B is facing forward, the flow shifts from S604 to S605 of FIG. 11A. In S605, because the face size at the wide-angle zoom position is 120, the flow shifts to S606. In S606, because the face confidence score is 80, the flow shifts to S607. In S607 of FIGS. 11A, 1 is added to the provisional registration count to become 31. In S609 and S610, because the provisional registration count is less than 50 but greater than zero, in S611, the provisional registration count is saved, and the flow then shifts to the determination for the next subject.

Because a subject 4 in FIG. 8B has the personal ID of zero in S602 of FIG. 11A, the processing in S603 and subsequent steps is executed. In S603, a reference is made to the provisional registration count up to the previous period, and in a case where the provisional registration count of the subject ID of 4 exists, the information is carried over.

Herein, it is assumed that the provisional registration count of the subject ID up to the previous period does not exist. In S604 of FIG. 11A, because the face direction is 90 degrees to the left, the flow shifts to S608, and the provisional registration count is set to zero. In S 609, because the provisional registration count is less than 50, the flow shifts to S610. In S610, because the provisional registration count is zero, the provisional registration count is not saved, and the processing is ended.

Subsequently, an example in which the provisional registration count becomes greater than or equal to 50 in S609 of FIG. 11A, and an example in which the subject set as the provisional registration target is arranged at a center of the angle of view through the panning drive, the tilting drive, and the zoom drive will be described. In a case where the subject 3 in FIG. 8B is set as the provisional registration target, such that the face position of the subject is within a predetermined range, a panning drive angle and a tilting drive angle are calculated. The predetermined range refers to a range in which the face position of the subject is at the screen center with a 5% margin, that is, an X position coordinate value is within a range from 432 to 528, and a Y position coordinate value is within a range from 513 to 567. Because the face size of the subject 3 falls within the range from 100 to 200, the zoom position is not changed.

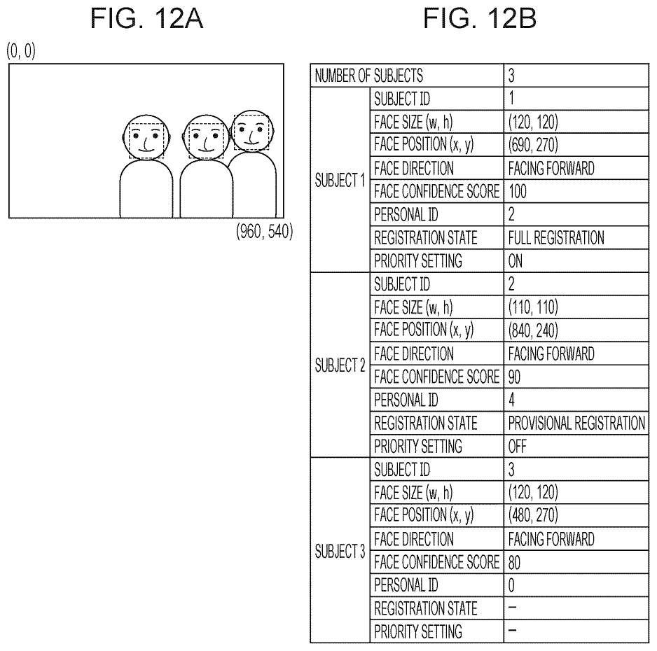

FIG. 12A illustrates an example of the image data in a case where the panning position and the tilting position are changed relative to FIG. 8A. FIG. 12B is a table illustrating an example of the subject information extracted in a case where the image data illustrated in FIG. 12A is input into the subject detection unit 1107. According to the present embodiment, by arranging the face at the center of the screen with an appropriate size, the feature information can be obtained in the feature information extraction unit 1105. In the provisional registration determination processing, it is determined that there is a possibility that an unregistered person who meets a specific condition over a plurality of periods is a key person, and the person is added to the personal information management unit 1106.

### Full Registration

Next, with reference to FIGS. 13A through 13C, the full registration determination processing illustrated in S504 of FIG. 10 will be described. FIG. 13A is a flowchart for describing the full registration determination processing performed by the full registration determination unit 1109. The present determination processing is executed over a plurality of periods similarly as in the provisional registration determination, and a key person is determined from among the already provisionally registered people.

FIG. 13B is a table illustrating a count A, a count B, and a full registration count linked to the personal ID. The count A and the count B are added under respectively different conditions, and when the value of the count A is greater than or equal to 50 or the value of the count B is greater than or equal to 50, the full registration count is added. In a case where the full registration count has reached 100, the relevant subject is determined to be a full registration target person. It is noted that each of the determination values of the counts A and B is variable according to the registration determination mode. Processing is performed such that the current count A, the current count B, and the full registration count are stored at the time of the determination in each period, and in the next period, references are made to those various counts obtained by accumulating the counts added up to the previous period, and the accumulated counts are carried over. It is noted that unless otherwise specified, each step in the flow of FIG. 13A is executed by the first control unit 223 or each unit of the camera 101 according to an instruction from the first control unit 223.

FIG. 13C is a table obtained by extracting only fully registered parts with regard to FIG. 9.

In S700, the registration determination mode obtained in S501 is set. With this configuration, the subsequent various determination values are switched. The determination values in the subsequent processing will be described by using an example in which the registration determination mode is basically a normal case.

In S701, iteration processing corresponding to the number of detected subjects is started. When the subject information is obtained from the subject detection unit 1107, the full registration determination unit 1109 executes the processing in S702 to S708 of FIG. 13A on each subject. In S702, the full registration determination unit 1109 performs a “provisional registration” determination. A reference is made to the registration state in the subject information, and in a case where it is determined that the registration is a “provisional registration,” the flow shifts to S703. In a case where it is determined that the registration is not a “provisional registration,” the flow shifts to the determination processing for the next subject.

In S703, the full registration determination unit 1109 refers to various counts stored up to the previous frame and in a case where various counts of the same personal ID exist, carries over the various counts. The full registration determination unit 1109 then executes a first full registration count determination (S704) and further executes a second full registration count determination (S705). The first full registration count determination (S704) is a determination based on the subject information of the person alone. Processing of adding the count A according to a distance between the target person and the image pickup apparatus and a confidence score to the full registration count is executed. In addition, the second full registration count determination (S705) is a determination based on a relevance to the already “fully registered” person who is already determined as a key person. Specifically, a plurality of “fully registered people” are detected at the same time, and processing of adding the count B according to whether or not distances from the image pickup apparatus are equivalent to the full registration count is executed. It is noted that details of first and second full registration count determination processing will be described below.

In the next step S706, the full registration determination unit 1109 compares the value of the full registration count of the relevant person with the threshold of 100. It is noted that this value is variable according to the registration determination mode. In a case where it is determined that the value of the full registration count is greater than or equal to 100, the flow shifts to S707. In a case where it is determined that the value of the full registration count is less than 100, the flow shifts to S708. In S707, the full registration determination unit 1109 instructs the personal information management unit 1106 to change the registration state of the relevant person to “full registration.” On the other hand, in S708, the full registration determination unit 1109 saves the current various counts. After S707 or S708, the flow proceeds to S709, and the determination on the end of the iteration processing is performed. In a case where the processing continues, the flow returns to S701, and the processing on the next detected subject continues.

Subsequently, with reference to a flowchart in FIG. 14, processing in S704 (first full registration count determination) of FIG. 13A will be described. The determination values in various flows are values in the table in FIG. 13C.

In S801, the full registration determination unit 1109 determines whether or not the face size at the wide-angle zoom position is within the range from 100 to 200. In a case where this condition is met, the flow shifts to S802, and in a case where this condition is not met, the flow shifts to S804.

In S802, the full registration determination unit 1109 determines whether or not the face confidence score is greater than or equal to the threshold of 80. It is noted that this value is variable according to the registration determination mode. In a case where this condition is met, the flow shifts to S803, and in a case where this condition is not met, the flow shifts to S804. In a case where all of the respective conditions in S801 and S802 are met, the flow shifts to S803, and processing of adding a value equivalent to the “face size at the wide-angle zoom position/10” to the count A is executed. It is noted that the face size/coefficient is variable according to the registration determination mode. In addition, in S804, the full registration determination unit 1109 sets the count A to zero, and the processing is then ended.

In the next step S805, the full registration determination unit 1109 compares the value of the count A with the threshold of 50. In a case where it is determined that the value of the count A is greater than or equal to 50, the flow shifts to S806, and in a case where it is determined that the count A is less than 50, the processing is ended. It is noted that this value is variable according to the registration determination mode. The full registration determination unit 1109 adds 1 to the full registration count in S806 and sets the count A to zero in S807. After S807, the processing is ended.

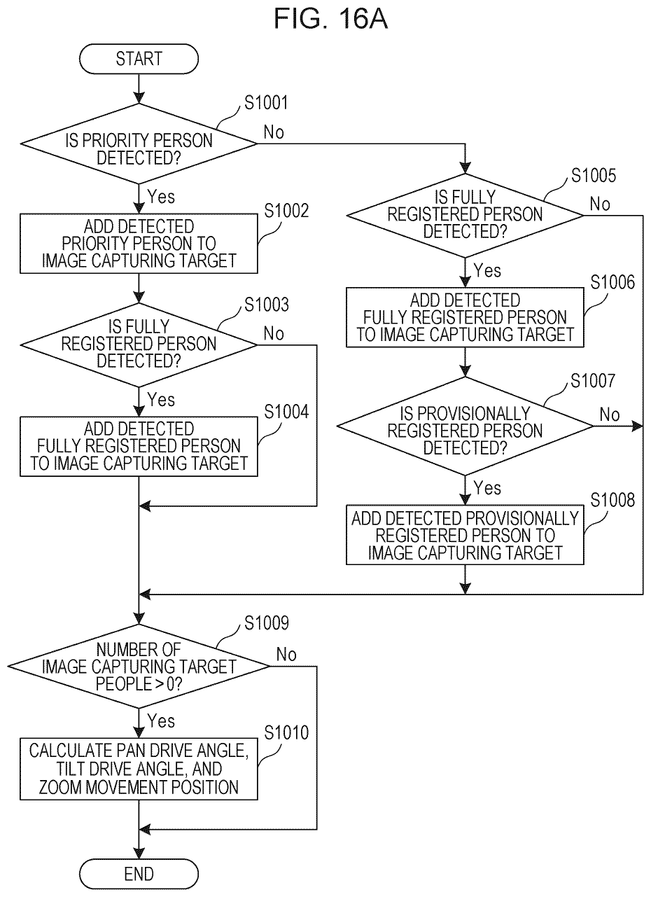

With reference to a flowchart in FIG. 15, the processing in S705 (second full registration count determination) of FIG. 13A will be described. The determination values in various flows are values in the table in FIG. 13C. It is noted that unless otherwise specified, each step in the flow of FIG. 15 is executed by the first control unit 223 or each unit of the camera 101 according to an instruction from the first control unit 223.

In S901, the full registration determination unit 1109 refers to the subject information and determines whether or not a plurality of people whose registration state is “full registration,” that is, people who are already determined as key people, are detected at the same time. In a case where it is determined that fully registered people are detected at the same time, the flow shifts to S902. In a case where it is determined that fully registered people are not detected at the same time, the flow shifts to S905.

In S902, the full registration determination unit 1109 refers to the face size in the subject information and determines whether or not the face size is similar to that of any of the fully registered people detected at the same time. Specifically, for example, in a case where the face size in the subject information is within a range of “±10% of the face size of the fully registered person” as the determination condition, the face size is regarded as being similar. In a case where the condition in S902 is met, the flow shifts to S903, and in a case where this condition is not met, the flow proceeds to S905.

In S903, the full registration determination unit 1109 compares the face confidence score with the threshold of 80. In a case where it is determined that the face confidence score is greater than or equal to 80, the flow shifts to S904. In a case where it is determined that the face confidence score is less than 80, the flow shifts to S905. It is noted that this value is variable according to the registration determination mode. In S904, the full registration determination unit 1109 adds a value equivalent to the “face size at the wide-angle zoom position/10” to the count B. It is noted that the face size/coefficient is variable according to the registration determination mode. On the other hand, in S905, the full registration determination unit 1109 sets the count B to zero and ends the processing.

Following S904, in S906, the full registration determination unit 1109 compares the value of the count B with the threshold of 50. In a case where it is determined that the value of the count B is greater than or equal to the threshold of 50, the flow shifts to S907. In a case where it is determined that the value of the count B is less than the threshold of 50, the processing is ended. It is noted that this value is variable according to the registration determination mode. The full registration determination unit 1109 adds 1 to the full registration count in S907 and sets the count B to zero in S908 and ends the processing.

Subsequently, a specific example of the full registration determination in a case where the full registration determination unit 1109 obtains the subject information illustrated in FIG. 8B will be described. It is noted that the zoom position is set to zero. With regard to each of the subject 1, the subject 3, and the subject 4 in FIG. 8B, because the registration state is not “provisional registration” in S702 of FIG. 13A, the processing in S703 and subsequent steps is not executed. With regard to the subject 2 in FIG. 8B, because the registration state is “provisional registration” in S702 of FIG. 13A, the processing in S703 and subsequent steps is executed.

In S703 of FIG. 13A, references are made to the count A, the count B, and the full registration count up to the previous period, and in a case where various counts of the personal ID of 4 exist, the information is carried over. As illustrated in FIG. 13B, the count A, the count B, and the full registration count of the personal ID of 4 up to the previous period are respectively set to 30, 40, and 70. A sum of respective values of the count A and the count B is the value of the full registration count. In S704 of FIG. 13A, the first full registration count determination is executed. In S801 of FIG. 14, because the face size at the wide-angle zoom position is 110, the flow shifts to S802. In S802, because the face confidence score is 90, the flow shifts to S803. In S803 of FIG. 14, because the face size at the wide-angle zoom position is 110, 11 (=110/10) is added to the count A, so that the count A becomes 41 (=30+11). In S805 of FIG. 14, because the value of the count A is less than the threshold of 50, the first full registration count determination processing is ended.

Subsequently, in S705 of FIG. 13A, the second full registration count determination is executed. In S901 of FIG. 15, a reference is made to the subject information, and it is found that the registration state of the subject 1 that is detected at the same time is “full registration.” It is determined that fully registered people are detected at the same time, and the flow shifts to S902. In S902 of FIG. 15, the subject 1 and the subject 2, who are the fully registered people, are compared in terms of the face size. In a case where the face size of the subject 2 is 120±10%, that is, from 108 to 132, because the face size of the fully registered subject 1 is 120, it is determined that the face size of the subject 2 is similar to that of the subject 1. Because the face size of the subject 2 is 110, it is determined that the face size of the subject 2 is similar to that of the fully registered person (subject 1), and the flow shifts to S903. In S903, because the face confidence score is 90, the flow shifts to S904.

In S904 of FIG. 15, because the face size at the wide-angle zoom position is 110, 11 (=110/10) is added to the count B, and the count B becomes 51 (=40+11). In S906 of FIG. 15, because the count B is greater than or equal to 50, the flow shifts to S907. In S907, 1 is added to the value of the full registration count 70, and the value becomes 71. In S908, after the count B is set to zero, the second full registration count determination processing is ended. Subsequently, in S706 of FIG. 13A, because the value of the full registration count is less than the threshold of 100, the flow shifts to S708. Processing of saving various counts is executed in which the count A of the personal ID of 4 is 41, the count B is 0, and the full registration count is 71.

It is determined by the full registration determination processing that the provisionally registered person who continuously meets the condition that the distance to the image pickup apparatus is within a predetermined range or the distance to the person already determined as the key person is close over a plurality of periods is a key person. The personal information management unit 1106 can perform the update based on this determination result.

### Image Capturing Target Determination

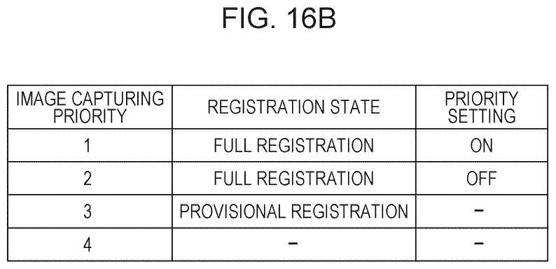

With reference to FIG. 16A and FIG. 16B, details of the image capturing target determination processing illustrated in S508 of FIG. 10 will be described. FIG. 16A is a flowchart for describing processing performed by the image capturing target determination unit 1110. The present processing is executed in each period, and a person set as the image capturing target is determined from among the detected people. It is noted that unless otherwise specified, each step in the flow of FIG. 16A is executed by the first control unit 223 or each unit of the camera 101 according to an instruction from the first control unit 223.

When the subject information is obtained from the subject detection unit 1107, the image capturing target determination unit 1110 executes processing in S1001 to S1008 and determines a subject set as the image capturing target. The panning drive angle, the tilting drive angle, and the zoom movement position are calculated based on the determination result in the processing in S1009 and S1010.

In S1001, the image capturing target determination unit 1110 refers to the subject information and determines whether or not a person whose priority setting is “on” is detected. In a case where the person is detected, the flow shifts to S1002, and in a case where the person is not detected, the flow shifts to S1005.

In S1002, the image capturing target determination unit 1110 adds the person whose priority setting is “on” to an image capturing target person, and the flow shifts to S1003. In S1003, the image capturing target determination unit 1110 refers to the subject information and determines whether or not a person whose registration state is “full registration” is detected. In a case where the person is detected, the flow shifts to S1004, and in a case where the person is not detected, the flow shifts to S1009. In S1004, the image capturing target determination unit 1110 adds the person whose registration state is “full registration” to the image capturing target person, and the flow shifts to S1009.

In a case where the person whose priority setting is “on” is detected, it is determined in the processing in S1001 to S1004 that the person whose priority setting is “on” and the person whose registration state is the “full registration” are the image capturing target people. In S1005, the image capturing target determination unit 1110 refers to the subject information and determines whether or not a person whose registration state is “full registration” is detected. In a case where the person is detected, the flow shifts to S1006, and in a case where the person is not detected, the flow shifts to S1009. In S1006, the image capturing target determination unit 1110 adds the person whose registration state is “full registration” to the image capturing target person, and the flow shifts to S1007.

In S1007, the image capturing target determination unit 1110 refers to the subject information and determines whether or not a person whose registration state is “provisional registration” is detected. In a case where the person is detected, the flow shifts to S1008, and in a case where the person is not detected, the flow shifts to S1009. In S1008, the image capturing target determination unit 1110 adds the person whose registration state is “provisional registration” to the image capturing target person, and the flow shifts to S1009.

In a case where the person whose priority setting is “on” is not detected and the person whose registration state is “full registration” is detected, the image capturing target person is determined by the processing in S1006 to S1008. In other words, the person whose registration state is “full registration” and the person whose registration state is “provisional registration” are determined as the image capturing target people.

In S1009, the image capturing target determination unit 1110 determines the number of people set as image capturing targets. In a case where it is determined that the number of the image capturing target people is one or more, the flow shifts to S1010. In a case where it is determined that the number of people set as image capturing targets is zero, the processing is ended. In S1010, the image capturing target determination unit 1110 calculates a panning drive angle, a tilting drive angle, and a zoom movement position such that the image capturing target fits within the angle of view and outputs those calculated values to the drive control unit 1111.

FIG. 16B is a table illustrating a priority level of a person according to the registration state in the subject information and the priority setting. An image capturing priority is represented by numerical values from 1 to 4, where 1 means the highest image capturing priority, and 4 means the lowest image capturing priority as follows:
a person whose image capturing priority is 1 is a person whose registration state is “full registration” and whose priority setting is “on;”
a person whose image capturing priority is 2 is a person whose registration state is “full registration” and whose priority setting is “off;”
a person whose image capturing priority is 3 is a person whose registration state is “provisional registration;” and
a person whose image capturing priority is 4 is an unregistered person.

In accordance with the processing of FIG. 16A, in a case where a person whose image capturing priority is 1 is detected, the image capturing target determination unit 1110 sets a person whose image capturing priority is 1 or 2 as the image capturing target and does not set a person whose image capturing priority is 3 or 4 as the image capturing target. In addition, in a case where a person whose image capturing priority is 1 is not detected and a person whose image capturing priority is 2 is detected, the image capturing target determination unit 1110 sets a person whose image capturing priority is 2 or 3 as the image capturing target and does not set a person whose image capturing priority is 4 as the image capturing target. Furthermore, in a case where a person whose image capturing priority is 1 or 2 is not detected, a determination result is obtained in which none of the subjects is set as the image capturing target.

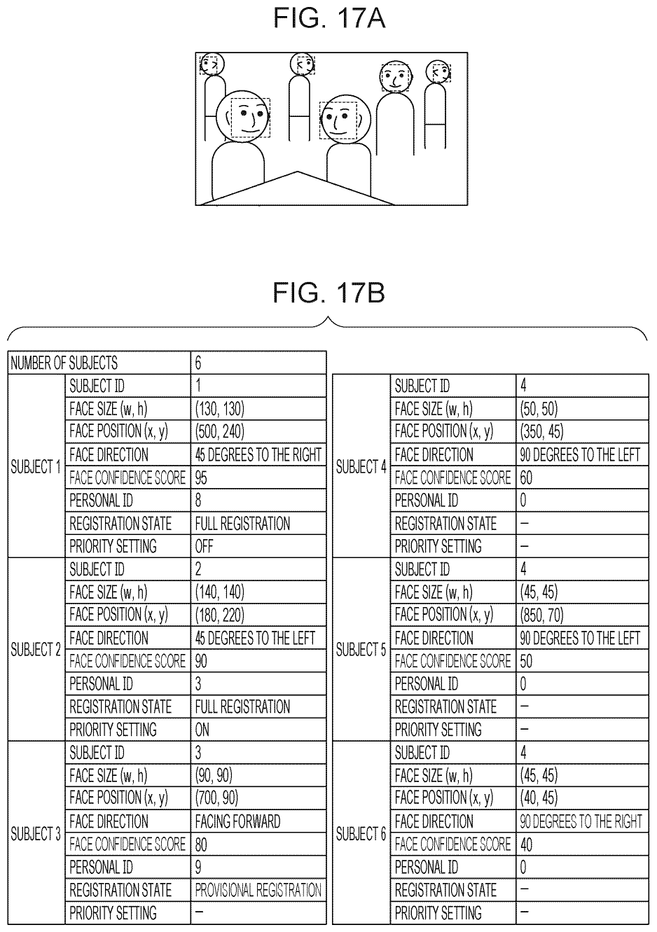

FIG. 17A illustrates an example of image data, and FIG. 17B is a table illustrating an example of the subject information. FIG. 17A is a schematic diagram illustrating an example of image data input into the subject detection unit 1107. FIG. 17B is a table illustrating an example of the subject information extracted in a case where the image data illustrated in FIG. 17A is input into the subject detection unit 1107. In the example of FIG. 17B, the number of subjects is 6, and the information of the subject ID, the face size, the face position, the face direction, the face confidence score, the personal ID, the registration state, and the priority setting for each of the six subjects is illustrated. A specific example of the image capturing target determination in a case where the image capturing target determination unit 1110 obtains the subject information illustrated in FIG. 17B will be described. It is noted that the zoom position is set to zero.

In S1001 of FIG. 16A, a reference is made to the subject information in FIG. 17B, and because the priority setting of the subject 2 is “on,” the flow shifts to S1002, and the subject 2 is added as the image capturing target. In S1003, a reference is made to the subject information in FIG. 17B, and because the registration state of the subject 1 is “full registration,” the flow shifts to S1004, and the subject 1 is added as the image capturing target.

In S1009 of FIG. 16A, because the number of people set as the image capturing targets is 2, the flow shifts to S1010. In S1010, a panning drive angle, a tilting drive angle, and a zoom movement position are calculated such that the subject 1 and the subject 2 fit within the angle of view. A description on a specific calculation method for a numerical value such as an angle or a position is omitted. An example of the specific calculation method includes a method of designating the numerical value using an absolute value, a method of setting a minimum value for the drive angle or the position that can be designated and gradually changing the value to the target angle or position over a plurality of periods, or the like.

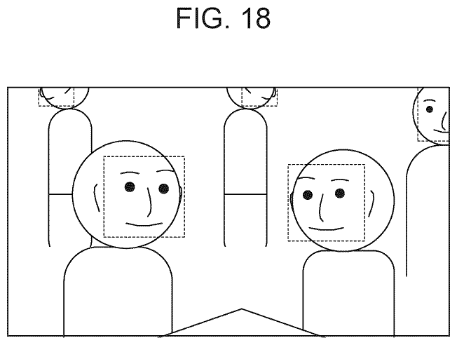

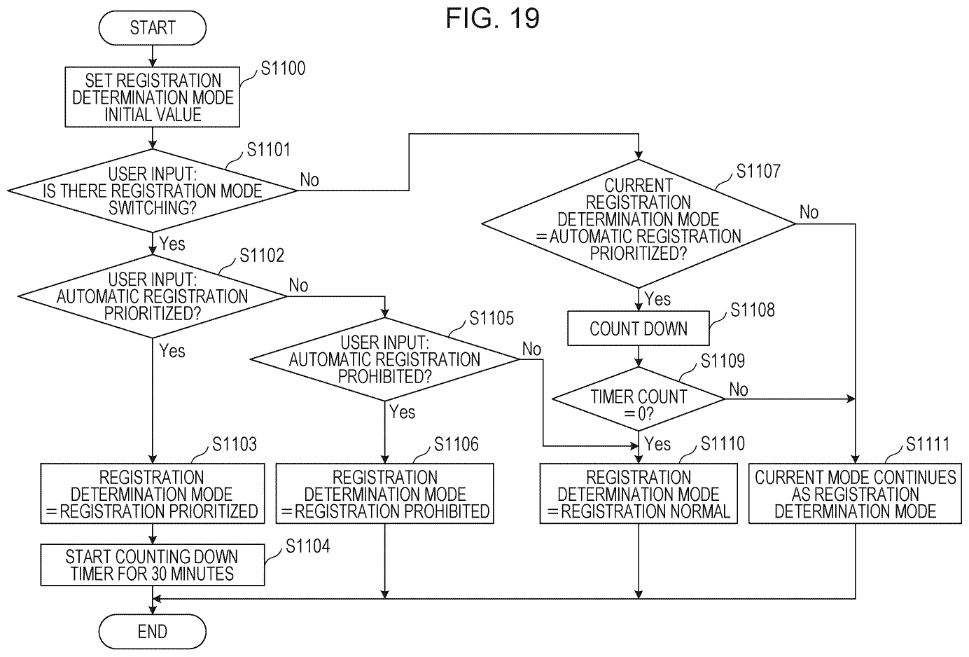

FIG. 18 is a schematic diagram illustrating an example of the image data as a result of the control by the drive control unit 1111 on each of the drive units following inputs of the panning drive angle, the tilting drive angle, and the zoom movement position that have been calculated. In the example of FIG. 18, the control of the panning drive, the tilting drive, and the zoom position movement is performed such that the center of gravity of face positions of the subject 1 on the right side and the subject 2 on the left side is arranged at a central part of the screen and the face size of each of the subjects falls within the range from 150 to 200.

In accordance with the above-described control, the image capturing can be performed such that the subject 1 and the subject 2, who are the image capturing targets and are determined to have high image capturing priority, are within the angle of view and the subjects 3 through 6, who are not the image capturing targets and are determined to have low image capturing priority, are out of the angle of view. In a case where people having a certain degree of image capturing priority or above are detected, processing is executed such that people having a similar image capturing priority are set as the image capturing targets, and people having an image capturing priority diverged from that of the key person are not set as the image capturing target. As a result, while the key person is set as the image capturing target, image capturing can be implemented by excluding people having a low relevance from the image capturing targets as much as possible.

Thus far, the control to decide the image capturing targets by performing the provisional registration and the full registration has been described. In the control, ease of the registration can be changed by switching the registration determination mode, and the provisional registration and the full registration can be used appropriately according to the scene.

Hereinafter, how the registration determination mode is switched will be described. With this configuration, according to the present embodiment, in a case where the automatic image capturing and the automatic authentication registration are performed by using a single image pickup apparatus, the appropriate automatic authentication registration according to a scene can be performed without causing any trouble to the user.

With reference to FIG. 19, details of an embodiment of processing of obtaining the registration determination mode illustrated in S501 of FIG. 10 will be described. According to this embodiment, the user themselves can switch the automatic registration to any determination mode with ease. Examples of the registration determination mode include the automatic registration normal mode, the automatic registration priority mode, and the automatic registration prohibition mode. It is noted that unless otherwise specified, each step in the flow of FIG. 19 is executed by the first control unit 223 or each unit of the camera 101 according to an instruction from the first control unit 223.

As an input unit of the user, for example, the following units are proposed:
a mobile terminal apparatus (external apparatus 301) configured to communicate with the camera 101 where an operation command is input by an input unit configured to switch a mode by a remote controller, an application of a smartphone, or the like; or
an operation command for switching a mode is input through an audio input into the audio input unit 213 of the camera 101.

The present flowchart is periodically executed in iteration processing of FIG. 10. It is noted however that the above-described user input is performed asynchronously with the iteration processing, and there is an input at any timing although not illustrated in the drawing.

In S1100, an initial value of the registration determination mode after activation is set, which is executed only once after the activation, and a mode stored in the non-volatile memory 216 is obtained to be set. At the time of factory shipment and the time of setting initialization, the automatic registration normal mode is stored.

Next, in S1101, in a case where there is a user input to switch the mode, the flow shifts to S1102 to execute the command of the user, and in a case where there is no user input to switch the mode, the flow shifts to S1107.

In S1102, in a case where the user input designates the automatic registration priority mode, the flow shifts to S1103. In a case where the user input does not designate the automatic registration priority mode, the flow shifts to S1105. In S1105, in a case where the user input designates the automatic registration prohibition mode, the flow shifts to S1106. In a case where the user input does not designate the automatic registration prohibition mode, the flow shifts to S1110.

In S1103, the registration determination mode is set as the automatic registration priority mode as designated by the user. This mode is set by the user in a case where, when the camera is started to be used in a situation where a plurality of unregistered acquaintances exist, it is desired that people nearby, that is, acquaintances, are automatically registered as soon as possible. If this priority mode continues without change, the automatic registration is to be performed by priority even in a case where an arrangement of the camera is changed or a scene is changed. Therefore, the registration priority is to be cancelled after a while. The user may input another registration determination mode, but at this moment, a timer for a sufficient period of time to automatically register people in the surrounding environment of the camera is set, and when the timer runs out, the registration determination mode is automatically switched to the automatic registration normal mode. In S1104, to cancel the automatic registration priority mode, counting down the timer for 30 minutes is started, and the present processing is ended. The counting down is determined in the next period processing.

In S1106, the registration determination mode is set as the automatic registration prohibition mode as designated by the user, and the processing is ended. This mode is a mode to be set in a case where, when the camera is used in a public area where there are an unspecified number of people who are not acquaintances, the automatic registration is not to be performed at all such that undesired people are not registered.

S1107 corresponds to a case where there is no user input from the previous period processing up to the current period processing, and when the current registration determination mode is the automatic registration priority mode, the flow shifts to S1108. In a case where the current registration determination mode is not the automatic registration priority mode, the flow shifts to S1111. In S1111, the registration determination mode is not changed, and the current registration determination mode continues.

The flow shifts to S1108 in a case where the countdown occurs in the registration priority mode. The countdown continues, and in S1109, in a case where the count has not reached 0, the flow shifts to S1111, and the current mode continues. In a case where the count has reached 0, the flow shifts to S1110, and the registration determination mode is restored to the automatic registration normal mode and the processing is ended.

With this configuration, only when the user starts to use the camera in a home party, a barbeque, or the like, by merely setting the registration priority mode, it is in an automatic manner that the camera automatically registers many acquaintances, and without performing an operation by the user afterwards, the mode is shifted to the normal mode to carry out the normal control.

In addition, by merely performing an operation of changing the mode only if the arrangement of the camera is changed, it is possible to provide the appropriate automatic registration according to the scene without inconveniencing the user as much as possible.

### Second Embodiment

With reference to FIG. 20 and FIG. 21, details of an embodiment of the processing illustrated in S501 of FIG. 10 to obtain registration determination modes will be described. According to this embodiment, the registration determination modes can be switched by using the GPS position information. Examples of the registration determination modes include the automatic registration normal mode and the automatic registration prohibition mode.

As described with reference to FIG. 3 and FIG. 4, the camera 101 can obtain the GPS position information by the GPS reception unit 405 of the external apparatus 301.

A current position 701 in FIG. 20 indicates a current position on the GPS position information of the external apparatus 301 that is a mobile terminal apparatus such as a smartphone. Because the camera 101 and the external apparatus 301 perform transmission and reception of the movement information based on BLE, which is short-distance line communication, a state is comparable in which the camera 101 and the external apparatus 301 are in the same position.

A building in a location at the current position 701 is a venue used for a home party or a barbeque and is basically a private area where it is supposed that there are acquaintances of the user.

To designate a private area by using an application of the external apparatus 301 that is a mobile terminal apparatus such as a smartphone, the user taps and designates a center position 702 (coordinates: XX.XXX, YY.YYY). A position range 703 indicates a range centered on the center position 702, and a size of the position range 703 can be changed in vertical and horizontal directions through a slide operation, a swipe operation, or the like of the smartphone.

In a case where a movement across this position range 703 is sensed, the external apparatus 301 notifies the camera 101 of movement information via the BLE control unit 402.

FIG. 21 is a flowchart which is periodically executed in the iteration processing of FIG. 10 and in which the registration determination mode is set by using the information of the position range obtained in FIG. 20.

In S1201, in a case where a designation of the mode switching depending on the area obtained by using the external apparatus 301 is performed, the flow shifts to S1203. In a case where no designation is performed, the flow shifts to S1202. In S1202, the registration determination mode is set as the automatic registration normal mode and the processing is ended. It is noted that, unless otherwise specified, each step in the flow of FIG. 21 is executed by the first control unit 223 or each unit of the camera 101 according to an instruction from the first control unit 223.

In S1203, information on whether or not the current position is within the above-described position range is obtained. In the obtaining of the current position, because the external apparatus 301 asymmetrically notifies the camera 101 of the information on whether or not the current position is within the position range, a reference is made to the information. As the information on whether or not the current position is within the position range, coordinate information may be obtained, so that the camera 101 can make a determination of whether or not the current position is within the position range, or a method of periodically issuing a query from the camera 101 to the external apparatus 301 may also be used.

In S1204, in a case where the current position is out of the position range, the flow shifts to S1205, and the registration determination mode is set as the automatic registration prohibition mode and the processing is ended. In a case where the position is within the position range, the flow shifts to S1202, and the registration determination mode is set as the automatic registration normal mode and the processing is ended.

With this configuration, only when the user starts a home party, a barbeque, or the like and starts to use the camera, by merely setting the position, the registration mode is automatically changed depending on an area where the camera is present. It is possible to provide the appropriate automatic registration according to the scene without causing any trouble to the user.

### Third Embodiment

In FIG. 20 and FIG. 21, whether or not the position is within the position range is determined by using the GPS position information, but in FIG. 22, an embodiment will be described where the determination mode is switched by using the gyro sensor included in the angular velocity meter 106 or the acceleration sensor included in the accelerometer 107. Examples of the registration determination mode include the automatic registration normal mode and the automatic registration prohibition mode.

The present flowchart is periodically executed in the iteration processing of FIG. 10. It is noted that, unless otherwise specified, each step in the flow of FIG. 22 is executed by the first control unit 223 or each unit of the camera 101 according to an instruction from the first control unit 223.

According to the present embodiment, as in FIG. 19, an operation command regarding whether or not a restriction mode depending on the position range is set to be ON is issued through an audio input or the like by the user. In S1301, in a case where no operation command is issued, the flow shifts to S1308, and in S1308, the registration determination mode is set as normal and the processing is ended. In a case where the operation command for setting the registration determination mode as the automatic registration prohibition mode is issued, the flow shifts to S1302. In S1302, only the first time the mode shift operation command is issued, the position at a range center is reset as a location where the user input is issued. The setting of the range center may be performed through a designation by the external apparatus 301 as in FIG. 20.

In S1303, a movement distance from the previous period processing is obtained by using acceleration information.

Next, in S1304, gyro information is obtained as information of a movement direction.

Next, in S1305, a position relative to the range center position is calculated based on the current position, the movement distance, and the movement direction calculated in the previous period processing.

Next, in S1306, it is determined whether a distance to the center position is, for example, 10 meters or more. In a case where the distance to the center position is 10 meters or more, it is determined that the position is outside a private area (=within a public area), and the flow shifts to S1307 to set the registration determination mode as the automatic registration prohibition mode and the processing is ended. In a case where the distance to the center position is 10 meters or less, the flow shifts to S1308 and the registration determination mode is set as the automatic registration normal mode and the processing is ended. A configuration may be adopted in which the distance from the center may be changed by a user input.

With this configuration, even in a situation where GPS is not used or a case where a battery remaining amount of the camera 101 or the external apparatus 301 is desired to be explained, the registration determination mode can be appropriately set.

In addition, according to the embodiment, the image pickup apparatus in which the lens barrel including the image capturing optical system and the image pickup element and the image pickup control apparatus configured to control the image pickup direction by the lens barrel are integrated has been described as an example. However, the present disclosure is not limited to this. For example, the image pickup apparatus may adopt a configuration in which the lens can be replaced.

In addition, a similar function can be realized by fixing the image pickup apparatus to a pan head including a rotation mechanism configured to drive the fixed image pickup apparatus in the pan direction and the tilt direction. It is noted that the image pickup apparatus may have other functions as long as the image pickup apparatus has the image pickup function. For example, by combining a pan head to which a smartphone having an image pickup function can be fixed and the smartphone, a configuration similar to the embodiment can also be achieved. In addition, the lens barrel and its rotation mechanism (the tilt rotation unit and the pan rotation unit) and the control box do not necessarily need to be physically connected. For example, the rotation mechanism or the zoom function may be controlled via a wireless communication such as Wi-Fi.

In addition, according to the embodiments, the example has been described in which the feature information of the person is obtained by the image pickup apparatus. However, for example, a configuration may be adopted in which the face image or the feature information in the personal information may be added from another image pickup apparatus for face registration or an external device such as a mobile terminal apparatus.

Embodiments of the present disclosure have been described above, but the present disclosure is not limited to these embodiments, and various alterations and modifications can be made within the gist of the present disclosure.

In accordance with the aspect of the present disclosure, by simple user operation, ease of the automatic authentication registration can be appropriately switched according to the scene.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-220208, filed Dec. 16, 2024, and No. 2025-169776, filed Oct. 7, 2025, the entirety of which are incorporated herein by reference.

What is claimed is:

1. An image processing apparatus capable of controlling automatic image capturing and automatic authentication registration, the image processing apparatus comprising at least one processor and at least one memory storing a program which, when executed by the at least one processor, causes the at least one processor to function as:
a search unit configured to search for a subject detected from image data obtained by picking up an image of the subject by an image pickup unit;
an authentication registration unit configured to perform authentication registration by authenticating the subject detected as a result of the search by the search unit and storing information about the subject; and
a control unit configured to control image pickup by the image pickup unit based on the information stored by the authentication registration unit, wherein
in order to determine whether the authentication registration by the authentication registration unit is to be performed, the control unit has a first authentication registration determination mode for determining whether or not a first discrimination condition is met, and
a second authentication registration determination mode for determining whether or not a second discrimination condition different from the first discrimination condition is met, and
the control unit performs switching of authentication registration determination modes including the first authentication registration determination mode and the second authentication registration determination mode by using at least one or more pieces of information among mode switching input information provided by a user, position information, time information, or sensor information.

2. The image processing apparatus according to claim 1, wherein the first discrimination condition is a combination of at least one or more conditions among a size of a face of the subject, a face detection confidence score, a face direction, a subject detection time period, a subject detection point in time, or a score of relevance to a registered person.

3. The image processing apparatus according to claim 1, wherein as compared with the first discrimination condition, a condition where it is less likely to be determined that the authentication registration is performed or more likely to be determined that the authentication registration is performed is set as the second discrimination condition.

4. The image processing apparatus according to claim 1, wherein the discrimination conditions further include one or more discrimination conditions different from the first discrimination condition and the second discrimination condition.

5. The image processing apparatus according to claim 4, wherein one of the discrimination conditions is a condition in which authentication registration is not performed.

6. The image processing apparatus according to claim 1, wherein the user provides mode switching input information to the control unit from an external apparatus wirelessly connected to the image processing apparatus, an audio input into the image processing apparatus, a remote control for the image processing apparatus, or an operation member included in the image processing apparatus.

7. The image processing apparatus according to claim 1, wherein after an authentication registration determination mode is switched, the control unit performs switching to a mode other than the currently switched mode after a predetermined time period has elapsed.

8. The image processing apparatus according to claim 1, wherein the control unit uses position information of the image processing apparatus and switches an authentication registration determination mode depending on whether or not the position information indicates that the image processing apparatus is within a predetermined range.

9. The image processing apparatus according to claim 1, wherein the control unit obtains position information of the image processing apparatus by using any one or both of position information of an external apparatus wirelessly connected to the image processing apparatus or position information calculated by using an acceleration sensor or an angular velocity sensor included in the image processing apparatus.

10. An image processing method enabling control of automatic image capturing and automatic authentication registration, the image processing method comprising:
searching for a subject detected from image data obtained by picking up an image of the subject by an image pickup unit;
performing authentication registration by authenticating the subject detected as a result of the search and storing information about the subject; and
controlling image pickup by the image pickup unit based on the information stored in the performance of the authentication registration, wherein
in order to determine whether the authentication registration is to be performed,
a first authentication registration determination mode for determining whether or not a first discrimination condition is met, or
a second authentication registration determination mode for determining whether or not a second discrimination condition different from the first discrimination condition is met is applied in the controlling, and
switching of authentication registration determination modes including the first authentication registration determination mode and the second authentication registration determination mode is performed by using at least one or more pieces of information among mode switching input information provided by a user, position information, time information, or sensor information.
